(19) United States
(12) Patent Application Publication
(10) Pub. No.: US 2019/0096535 A1
(43) Pub. Date: Mar. 28, 2019

(54) THE METHOD OF GENERATING THERMAL ENERGY, DEVICES OF ITS IMPLEMENTATION AND HEAT GENERATION SYSTEMS

(71) Applicant: POWER HEAT ENERGY S.R.O., Nusle (CZ)

(72) Inventors: Oleg OLSHANSKY, Vary (CZ); Emanuel HUBENY, Praha 5 (CZ); Andrey KOLOSOV, Volgograd (RU)

(73) Assignee: POWER HEAT ENERGY S.R.O., Nusle (CZ)

(21) Appl. No.: 16/082,936

(22) PCT Filed: Mar. 3, 2017
(86) PCT No.: PCT/CZ2017/050011

§ 371 Date: Sep. 7, 2018

(30) Foreign Application Priority Data
Mar. 8, 2016 (CZ) PV 2016-136

(51) Int. Cl. G21B 3/00

(52) U.S. Cl. CPC G21B 3/002

(57) ABSTRACT

The invention belongs to the category of devices used for thermal energy generation based on the principles of low energy nuclear synthesis, so-called LENR reactions. The specific aspect of these reactions is the low energy consumption by the heating devices, while maintaining sufficiently high output of the thermal energy generated by these devices. The declared methods and alternatives of the device enable, with the use of the heaters, the implementation of various schemes of use in liquid and air heating systems. The heater is constructed as a porous ceramic electrically conductive tubular element made of a high-temperature withstanding ceramic and a reaction material comprising a mixture of metallic powders in the form of metal powder of the elements of the 10th group of the Periodic Table, such as nickel (Ni), and a fuel mixture containing the chemical elements lithium (Li) and hydrogen (H), proportionally distributed inside the pores in a ratio ranging between 10 and 80% of the surface of the heater pores, or in a different alternative where the porous ceramic electrically conductive tubular element is made of a high-temperature withstanding ceramic containing a catalyst metallic powder in the form of metal powder of the elements of the 10th group of the Periodic Table, such as nickel (Ni).

### FIELD OF APPLICATION

The submitted invention relates to the field of thermal energy production based on the principles of the so-called Low Energy Nuclear Reaction (LENR). In addition, the invention relates to the heating device performing such reactions. The specific aspect of these reactions is the low energy consumption by the heating devices, while maintaining sufficiently high output of the generated thermal energy. The devices are adapted for the use of hydrocarbon resources for heat initiation or for the use of electric energy and their efficiency is further increased based on the principles of combined construction of the heating devices.

### CURRENT STATUS OF THE TECHNOLOGY DEVELOPMENT

The development of the technology of devices based on LENR principles recently implemented as alternative energy systems for the production of thermal energy is being utilised in various projects published by research institutions and manufacturers of power generation devices. Nonetheless, to this date, no devices have been implemented for full commercial use, due to the constraints associated with keeping the reactors in the operation mode, maintenance of the parameters control during the nuclear synthesis process and of the temperature mode in the environment of the fuel mixture.

The goal of this invention are the methods implementing the technology of LENR devices—heaters and heating devices—ensuring the required reliability, control of the reaction process, and increasing of the device efficiency, practical use, utilisation of the electric energy, and a wide range of energy sources for the initiation heat impact, such as hydrocarbon fuels.

The aforementioned methods, heaters and heating device, as well as the control system, are intended for the production of thermal energy and are based on the utilisation of thermal energy released in the course of the catalytic exothermic LENR reaction in the reaction material consisting of the catalyst—powder of the transient metals of the th group of the periodical table of elements, primarily nickel (Ni), and a fuel mixture of hydrogen-containing chemical compounds of aluminium (Al) and lithium (Li), with the construction of heating devices in the form of Thermo Energy Reactor (TER) with the controlled reaction process, as well as systems intended for their use.

Characteristic elements of the documented method of producing thermal energy, comprising the use of chemical elements involved in the exothermic reaction of the Low Energy Nuclear Reaction (LENR) and its alternatives, as described in this patent, is the continuous monitoring of the temperature of the reactive material consisting of a slightly dispersive catalyst in the form of metal powder of the transient metals of the 10th group of the Periodic Table, in particular nickel (Ni), and a fuel mixture, such as lithium aluminium hydride (LiAlH₄), and the maintenance of the reaction process temperature within the range of minus (5-10%) of the pre-determined temperature fluctuations until the start of the melting and sintering process of the catalyst powder, with the use of a heater produced as a porous ceramic electrically conductive tubular element with a reaction material being placed in its pores, the inner surface of which is being heated and the thermal energy is being removed from the outer surface, with metal contacts being placed on the opposite ends of the heater, connected to the input of the control system for controlling the electric resistance inside the heater, for which purpose they are subjected to voltage and the current value is being measured, and the first and/or second derivative of the current is being calculated for the control process, based on which the temperature is determined at which the LENR process occurs and that is maintained by means of disconnecting or connecting the thermal energy supply to the heater and the reaction material within the range minus (5-10%) of the initial melting temperature of the catalyst, for which purpose the thermal energy connection/disconnection control devices are connected to the control system output. The alternatives of the method include the thermal energy production by means of hydrocarbon fuel combustion, form example combustion gas, where the thermal energy can be received on the inner surface and removed from the outer surface of the heater, or alternatively, where the thermal energy can be received on the outer surface and removed from its inner surface; the thermal energy can also be received by means of electric current passing through the heater, guided through metal contacts.

Also, the characteristic elements of the device for the implementation of the claimed method: a heater structured as a porous ceramic electrically conductive tubular element made of ceramic material SiC, ZrO₂, Al₂O₃, with the reaction material being distributed in the pores and with metal contacts being placed on the opposite ends, to which electric conductors are connected made of high-temperature withstanding metal, as well as a heating device containing the aforementioned heater that receives external thermal energy of heating during combustion of hydrocarbon fuel, such as combustion gas, containing metal-coated (connection) contacts, connected at the opposite ends to electric conductors made of high-temperature withstanding metal; the heater is placed in a hermetically sealed cylindrical metal case made of high-temperature withstanding metal, preferentially a nickel (Ni) alloy, equipped with a ceramic insulation insert for guiding out the contact terminals in the area of the fixing flange, and also containing thermally insulated surfaces of heating and removal of the thermal energy, as well as the alternatives of the de constructed for the purpose of obtaining external thermal energy of heating by means of electric supply;

Also the construction alternative where additional thermal energy is being obtained and the efficiency is being increased through the use of a ceramic electrically conductive element with a reaction material placed in its pores, constructed as two electrically insulated coaxial cylindrical bodies constituting the initiation heater and the emission heater; the initiation heater receives external heating energy and heats the emission heater, with the produced thermal energy being removed from the outer surface of the emission heater. Metal contact outputs are placed on the opposite ends of the heater, connected to the input of the control system. For the purpose of electric resistance control inside the heaters, the contacts are subjected to voltage and the current value is being measured, and the first and/or second derivative of the current is being calculated for the control process, based on which the temperature is determined at which the LENR process occurs and this temperature is being maintained by means of disconnecting or connecting the thermal energy supply to the heaters and to the reaction material within the range minus (5-10%) of the initial melting temperature of the catalyst, for which purpose the appropriate control devices are connected to the control system output. The construction alternatives include the thermal energy production by means of combustion of hydrocarbon fuel, such as combustion gas, with the possibility of receiving thermal energy on the inner surface, where the thermal energy is being removed from the outer surface of the heater, or alternatively, where the thermal energy is received on the outer surface and removed from its inner surface of the heating device. The heaters also receive thermal energy by means of electric current passing through them, guided through metal contacts; The method where the initiation heater and the emission heater are divided into two or more sections with the aim of achieving smooth control of the output power; The method where in order to accelerate the initiation of the LENR reaction, the initiation heater and the emission heater, or the respective sections thereof, in the initial stage receive thermal energy by means of passing electric current guided through metal contacts;

Same as the device for the implementation of the claimed method: the heating device contains an initiation heater that receives external thermal energy of the heating by means of electric supply or by means of combustion of hydrocarbon fuel, such as combustion gas, and an emission heater, constructed as two electrically insulated coaxial cylindrical bodies with metal-coated (connection) contacts, connected at the opposite ends to electric conductors made of high-temperature withstanding metal, preferentially an alloy of nickel (Ni) and chrome (Cr), with the ends of the initiation heater and of the emission heater being connected at one side and having one terminal guided through the centre of the initiation heater, placed in a cylindrical metal case made of high-temperature withstanding metal, preferentially a nickel (Ni) alloy, equipped with ceramic insulation inserts for guiding out the contact terminals in the area of the fixing flange, and also containing thermally insulated surfaces of heating and removal of the thermal energy;

Alternative: heating device comprising an initiation heater divided into two, three or four sections, each of which has metal contacts connected to the control system, receiving external thermal energy of the heating, and an emission heater divided into two, three or four sections, each of which has metal contacts connected to the control system, constructed as two electrically insulated coaxial cylindrical bodies;

Alternative of the heating device in which the initiation heater receives the external thermal energy of the heating during combustion of hydrocarbon fuel, such as combustion gas, by means of two, three or four burners and the inner surface of the emission heater forms a flow chamber and its end exit sleeves are equipped with screw threads for the connection of the sockets for the supply and removal of the heated liquid (heating media);

Alternative of the heating device in which the sections of the initiation heater receive the external thermal energy of the heating by means of electric supply and the inner surface of the emission heater forms a flow chamber and its end exit sleeves are equipped with screw threads for the connection of the sockets for the supply and removal of the heated liquid;

Alternative of the heating device where the metal case is covered by porous ceramic material and equipped with a screw thread for its mounting.

Also the heating systems according to the patent, in which the heating devices are used, for example: The convection tubular electric heater with a vertical heat-conductive panel, on which a two-lamella radiator is fixed, with the angle of 95°-110° between the lamellae, with the developed surface where the tubular element is placed on the heat-conductive panel at an angle of 15°-25° and where the heating device, the metal case of which is covered with a porous ceramic material and equipped with a screw-thread connection, is hermetically fixed by means of the screw thread connection at the lower part of the tubular element, the other end of which is hermetically sealed, with the inside of the tubular element being filled with a liquid with the boiling point between 95° C. and 115° C. up to the level covering the surface of the heating device; Alternative of the convection tubular heater comprising a 4-lamella radiator fixed on the tubular element at an angle of 95°-110° between the lamellae;

Also, the liquid heating system of accumulation type containing a hermetic construction filled with liquid, sockets for the liquid supply and removal, burner with a closure valve connected to the source of hydrocarbon fuel, as well as the heating device containing an initiation heater that receives external thermal energy of heating by means of combustion of hydrocarbon fuel, such as combustion gas, and an emission heater, structured as two electrically insulated coaxial cylindrical bodies placed inside a cylindrical heat exchanger equipped with radial plates inside the construction and the exhaust pipe for removing combustion products of the fuel, a control system to which the heating device described above is connected, a liquid temperature sensor installed on the coat of the heat exchanger, a regulator of the gas fuel supply controlling the burner and the closure valve, a closing supply of the hydrocarbon fuel used when the liquid temperature exceeds 95° C., and an electronic temperature regulator that determines the required temperature values of the liquid heating;

Also, the liquid heating system of flow-through type containing a source of the gas fuel with a closure valve, a combustion chamber and a exhaust pipe for removing combustion products of the fuel, a heating device comprising an initiation heater that receives external thermal energy of heating by means of combustion of hydrocarbon fuel, such as combustion gas, with the use of four burners, where the internal surface of the emission heater creates a flow-through chamber, to the screw threads of which there are sockets connected for the supply and removal of the heated liquid; there are also four gas combined 3-nozzle burners installed at the outside of the heating device, a control system to which four regulators controlling the burners are connected, leading to four channels of the hydrocarbon fuel supply, a liquid temperature sensor installed on the outlet socket, a closure valve for closing the gas fuel supply when the liquid temperature exceeds 95° C., and a supply pump that regulates the speed of the heated liquid supply, and an electronic temperature regulator that determines the required temperature values of the liquid heating;

Also, the liquid heating system of accumulation type with the possibility of continuous regulation of the heating output, temperature sensor installed on the heat exchanger, a heating device comprising an initiation heater divided into four sections, each equipped with metal contacts connected to the control system, that receives external thermal energy of the heating and an emission heater divided into four sections, each equipped with metal contacts connected to the control system, structured as two electrically insulated coaxial cylindrical bodies placed inside a cylindrical heat exchanger equipped with radial plates inside the construction, a control system to which the heating devices are connected, a liquid temperature sensor the signal from which triggers the disconnection of the electrical energy supply into the heating device when the liquid temperature exceeds 95° C., and an electronic temperature regulator that determines the required temperature values of the liquid heating;

Also, the liquid heating system of flow-through type where the initiation heater receives external thermal energy of heating by means of combustion of hydrocarbon fuel, such as combustion gas, with the use of four burners, or where the sections of the initiation heater receive external thermal energy of heating by means of electric energy supply and where the internal surface of the emission heater creates a flow-through chamber, to the screw threads of which there are sockets connected for the supply and removal of the heated liquid; there is also thermal insulation on the outer surface of the heater and a control system to which the heating devices are connected, a temperature sensor of the maximum temperature of the surface of the coat of the heating device, a liquid temperature sensor installed on the inlet and outlet sockets, the signals of which trigger the disconnection of the electric energy supply when the liquid temperature exceeds 95° C., and a supply pump that regulates the speed of the heated liquid supply, and an electronic temperature regulator that determines the required temperature values of the liquid heating;

Also, a convection heater consisting of a frame, inside which a convection tubular electric heater is installed, with a vertical thermally conductive panel, on which a two-lamella radiator with developed surface is fixed, of an outlet and inlet deflector, and of a control system, to which the heating device is connected and a temperature sensor placed on the radiator plate that triggers the disconnection of the electrical energy supply when the temperature exceeds 75° C.-95° C., a temperature sensor on the outer surface of the convection heater for measuring the external temperature, an electronic temperature regulator that determines the required temperature values, and an electric fan regulating the speed of the air flow on the convection surface; The alternative of convection heater inside which a convection tubular electric heater is installed, with a four-lamella radiator fixed on a tubular element, and a control system, to which the heating device is connected and a temperature sensor placed on the radiator plate that triggers the disconnection of the electrical energy supply when the temperature exceeds 75° C.-95° C., a temperature sensor on the outer surface of the convection heater for measuring the external temperature, an electronic temperature regulator that determines the required temperature values.

Also, a universal control system based on a microcomputer, as the main control device with specialised software, implemented for functioning in accordance with the methods and devices pursuant to claims 1 through 31, in combination with the liquid heating systems of accumulation or flow-through type or convection heaters with various alternatives of heating devices utilising energy from the hydrocarbon fuel sources or from electric sources, containing terminal groups of contacts for the connection of one up to eight contacts from the sections of the initiation heater and the emission heater leading to the measuring unit consisting of eight resistors for the measuring of the electric resistance of individual sections of the heaters, connected to the 8-channel PWM (Pulse Width Modulator) of the electric output, connected to the supply source of the control system and to a microcomputer; the aforementioned 8 segments of the heater has a common contact and the electric voltage measured at the resistors is led to the input of the 8-channel analogue multiplexer connected to a microcomputer; the voltage values measured at the output of the microcomputer are led to the input of the ADC converter, the output of which is also connected to the input of the microcomputer; in addition, the system contains the end group of contacts for the connection of up to four temperature sensors determining the temperature of the heating device, the liquid and air; the temperature sensors are connected to the ADC converter, from which the measured values are transmitted to the input of the microcomputer; the liquid flow sensor is connected to the input of the signal digitisation block and then to the input of the microcomputer, and the group of contacts for the connection of the closure valve and the control unit of the hydrocarbon fuel burners, connected to the output of the microcomputer by means of a 4-channel DAC converter, and four groups of relay contacts for the connection of pumps, fans and/or other analogue devices needed for the operation of the heating system. Other devices of the control system connected to the microcomputer include electronic temperature regulator that determines the required temperature values of the heating of the controlled devices, heating of the liquid or volume of the ambient air, supply source of the control system, microcomputer and other devices, and standard computer communication interfaces for the connection of external devices used for programming, control and recording of information.

### Theoretic Explanation, Analogues and Prototypes of the Invention

The invention relates to the production of thermal energy by means of the LENR method (Low Energy Nuclear Reaction). Publishing of the information regarding the claimed patent relates to the methods of thermal energy production, the devices of Thermo Energy Reactor (TER) functioning in line with these methods, as well as the systems using the TER devices.

Currently, there are several theories relating to the process of releasing an abnormal endothermic thermal energy in the course of a catalyst reaction on the surface of metals of the 10th group of the Periodic Table with hydrogen-(H) or deuterium-(D) containing chemical compounds of aluminium (Al) and lithium (Li), activated by means of external thermal impacts or in combination with electromagnetic impacts. Theoretic assumptions motivate the research and development of the devices to be used as local sources of heat and electric energy.

However, the primary source of energy in the implemented devices are electric resistance heating elements (heaters), which significantly restricts the range of their use for the alternatives representing local and mobile production of thermal and electric energy.

Researches are known focused on heating devices of fuel mixtures in the core (in the active zone) in the form of a crystalline metal structure or fine dispersive powder of metals of the transient group, for example nickel, in the patents of the inventor of this technology, Francesco Piantelli.

According to the patent EP 0767962 B1, 27 Jan. 1995 and WO 95/20816 3 Aug. 1995 Inventor Francesco Piantelli ENERGY GENERATION AND MEANS OF ANHARMONIC STIMULATED FUSION—GENERATOR AND METHOD FOR ENERGY PRODUCTION BY NUCLEAR FUSION, the method of energy generating and device of realization of termogeneration by means of nuclear anharmonic stimulated nuclear fusion of hydrogen isotopes adsorbed on a crystalline lattice of transition metals are published.

This invention relates to energy generating by means of anharmonic nuclear synthesis, and particularly, to the method of energy generating by means of nuclear anharmonic stimulated nuclear fusion of hydrogen isotopes adsorbed on a crystalline lattice of the catalyst. Furthermore, the subject of invention is an energy generator, which carries out this process. The process of energy generating and the energy generator, based on the means of anharmonic stimulated nuclear fusion of hydrogen isotopes adsorbed by catalyst metal contains: a charging step of hydrogen isotopes H and deuterium D into the metallic core; a heating step, in which the core is heated to temperature higher than Debye temperature of material of the core fuel mixture; a startup step, wherein a vibrational stress is produced with a rise time less than 0.1 seconds, which activates a nuclear fusion of said hydrogen isotopes; a stationary step, in which the heat release of nuclear synthesis of hydrogen and deuterium (H+D), ongoing in the core due to continuous maintenance of the coherent multimodal system of stationary oscillations. The process of energy generation, able to arrange the process of nuclear synthesis of hydrogen isotopes adsorbed by metal, is ensured, the reproduction on an industrial scale is ensured without the high costs, the process is easily activated and deactivated.

According to the patent the method of energy generating is implemented by means of anharmonic stimulated nuclear synthesis of hydrogen isotopes absorbed by the crystalline metal core, including insertion of hydrogen isotopes into a metal core and heating of the core with its subsequent activation, in which additionally the isotopes of hydrogen H and deuterium D adsorbed on a crystalline lattice of the core are getting through the core, wherein the proportion of the content of D-isotopes to H— isotopes is higher than 1/80000, in the final phase of insertion of the concentration of H and D isotopes, adsorbed by metal, the numerical ratio of hydrogen isotopes and metal atoms exceeds, equal to 0.3, the core saturated with hydrogen isotopes is heated to a temperature above a threshold temperature corresponding to Debye constant temperature for the material forming the core, wherein this temperature is less than the value, in which the metal of core loses its crystalline structure, activation of the core is carried out with vibration with a pulse width shorter than 0.1 seconds, which activates a nuclear synthesis of hydrogen isotopes with subsequent ensuring of the stationary phase, in which the heat from the nuclear synthesis of H+D is released, occurring in the core due to continuous maintenance of the coherent multimodal system of stationary oscillations of the crystalline lattice, adsorbing the hydrogen.

The Debye temperature for metals applicable with the material of fuel mixture is the threshold temperature, which must be exceeded during the phase of heating. To activate the reaction, this threshold temperature should be exceeded, for the minimum value of T, in the range from several degrees to several tens of degrees, depending on the type of material forming the core. In any case, Debye constant can be calculated theoretically, since it is equal to TD=h/kcr, where h means the Planck constant, k means the Boltzmann constant and cr means the specific frequency of each material.

Natural hydrogen is convenient to be introduced into the core, the content of proportion of D and H isotopes is equal to about 1/6000. However, the activation of the reaction is also possible with natural hydrogen with depleted of or enriched volume of deuterium, content ratio of isotopes D and H is higher than 1/80000, and preferably range is between 1/10000 and 1/1000. It is supposed, that during the insertion phase, heating phase, activating phase and stationary phase, the influence of magnetic field with induction intensity higher than 0.1 Tesla is joined to the core. After completion of the stationary phase, the synthesis stops by cooling down the core to the temperature below the threshold temperature, or by creating additional resonance voltage, which disturbs coherent multimodal system of stationary oscillations, wherein the discontinuation comprises, after causing of temporary vacuum, introduction of polyatomic gas into the chamber containing the core, causing the additional resonant voltage. Startup phase is performed by means of thermal stresses, obtained by introducing of a polyatomic gas with pressure gradient value from 1 mbar up to 4 bars into a chamber containing the core.

The H2, D2, HD, HT, C2H4, NH3, N2, O2 or their mixture are used as the polyatomic gas. Startup phase is also carried out by a mechanical, torsional, tensile or compressive pulses added to the ends of mentioned core with a pulse width less than 0.1 second, or by electric shock pulses application to the core, or by means of laser beam pulses directed to the core, or by exposing of the core to radio pulses, whose frequency corresponds to the frequency of the plasma of free electrons of the crystalline lattice of the core, or by exposing the core to radio pulses, whose frequency corresponds to the resonance frequency of the spins of the hydrogen isotopes, or by acting of pulses of ultrasonic oscillations on the core placed in a resonant cavity, or by using of reverse piezoelectric effect applying the alternating voltage pulses to the ends of the metal core, with a frequency equal to the actual frequency of the core, or by using of magnetostriction effect by creating the magnetic field with peak values, which are higher than intensity of magnetic saturation, and a pulse duration is less than 0.1 seconds alongside the metallic core.

Energy generator, operated on the base of anharmonic stimulated nuclear fusion of hydrogen isotopes adsorbed on metal, performing the claimed method, comprises a crystalline metal core, on which surface the hydrogen isotopes are adsorbed, generating chamber surrounding the core, heat exchange means placed inside or around the generating chamber, in which the fluid, which removed the heat flows, means of creating a resonant stresses in the core with a pulse width less than 0.1 seconds, means of introduction of hydrogen isotopes into the metal core, and means of heating the core to a temperature above the Debye temperature and less, than the value, in which the metal of core loses its crystalline structure.

Active area is a metallic layer applied by electroplating or by using of metal powder on copper or ceramic base, placed in a generating chamber, and the means of creating of the resonant stresses in the core contains a piezoelectric electrode fixed to the core.

The strength of the theory is the conclusion of the Debye temperature, at which the reaction with the release of abnormal temperature takes place. We think that the Debye temperature in this case should be determined not only for a reaction material of the catalyst, but in conjunction with the material of the fuel mixture, which may exceed the tabulated value used in the calculation in the mentioned patent. Nevertheless, the device for implementing of the method according to the patent does not provide a detailed control of the temperature in the zone of nuclear synthesis, thereby the control process of Debye temperature in the core was not fully carried out. At the same time, the practical realization of the device according to the patent contained the heated outer element with a low reactivity, which was constructed as an external electrically resistive heater with a large response time to changes in the heating process, that in practice enable to obtain a practical realization of the theoretical conclusions. In the development of Francesco Piantelli theory, other of his patents, that extend the theoretical basis and practical implementation of thermo generating devices were published.

US Patent 2011/0249783 A1 Oct. 13, 2011 Inventor: Francesco Piantelli METHOD FOR PRODUCING ENERGY AND APPARATUS THEREFOR—Methods of generating of energy and devices for its implementation.

In accordance with the methods described in the patent, technologies of attainment of abnormal heat energy during the nuclear synthesis by nuclear fusion reaction between hydrogen atom (H—)-proton, or (H— iont) and reactive metal in the crystal structure of the nanopowder state, which forms predetermined cluster system with the fixed amount of metal atoms, such as nickel (Ni) and/or its isotopes are described. To begin the reaction of nuclear synthesis, the cluster system of reactive metal must react with atoms of hydrogen under certain conditions: obtaining predetermined heat energy and hydrogen gas pressure, as well as obtaining of the level of initiating temperature from 200° C. to 450° C. Moreover, the advanced condition of level of the critical temperature, which must be higher than the Debye temperature, is determined for the reaction metal. And also, initialization and keeping of reaction of nuclear synthesis with abnormal release of heat energy by exposing of trigger impulse actions, such as thermal shock hydrogen gas flow directed to the surface of the cluster reaction zones, the impact of mechanical impulse, ultrasonic pulse, laser beam, by electromagnetic field with frequency range higher than 1 kHz, by X-ray and gamma radiation (1 kHz; X rays; Y rays), pulse electric, by current flow of elementary particles, such as electrons, protons or neutrons, by pulsed flux flow of ions of chemical elements, such as O; Ar; Ne; Kr; Rn; N; Xe, by voltage pulse obtained on the piezo-element, as well as by magnetostriction pulse.

This patent, describing a method of heat generation and device for its implementation, is a continuation of the research methods of initialization and control of nuclear synthesis on metal surfaces in contact with a hydrogen atom to give an abnormal temperature effect.

Patent assume, that in the catalytic reactions are mainly used the metals, which have crystalline open porous structure to assist the H— ions in adsorption into the clusters. Preferably, the transition metal is nickel. In particular nickel, selected from the group consisting of: natural nickel, i.e. from a mixture of isotopes, such as nickel-58, nickel-60, nickel-61, nickel-62, nickel-64, as well as from the nickel powder, which contains only one isotope, selected from the group consisting of: nickel-58; nickel-60, nickel-61, nickel 62, nickel-64. H— ions can be prepared, under certain operating conditions, by treating of the hydrogen molecules H2, which were previously adsorbed on the surface of transition metal, on which a semi-free valence electrons forms the plasma. In particular, the heat is required to cause atomic lattice vibrations, i.e. release phonons, whose energy is higher than the first threshold of activation energy, due to nonlinear and anharmonic effects.

In such circumstances, the following situations can arise: the dissociation of hydrogen molecules adsorbed on the surface, the interaction with the valence electrons and the formation of H— ions; the adsorption of H— ions into clusters, in particular clusters, that forms a two or three crystal layer, which are closest to the surface. H— ions can physically interact with the metal, or may chemically react with it, in that case, the hydrides can be formed. H— ions can be also adsorbed at the lattice spacing, due to adsorption on grain edges, by trapping of the ions in the crystal lattice defects.

In the development of technology, various options of external initialization process factors are reviewed, but the strategy of basic initiating thermal effect remains outer, reaction material is exposed to an outer thermal effect from heated outer element with low reactivity, what remains a major drawback of the stated invention.

Another important source of information for the identification and development of theoretical aspects of nuclear synthesis and of the devices, that allow to implement this method is the patent US 2014/0098917 A1 Apr. 10, 2014 Inventor Francesco Piantelli.

### Method and Apparatus for Generating Energy by Nuclear Reactions of Hydrogen Adsorbed by Orbital Capture on a Nanocrystalline Structure of a Metal

A feature of this invention is a method and variants, using by which, the condition of receiving energy from the nuclear reactions between hydrogen and a transition metal is reached, where the method comprising the following steps: preparing of raw material, containing a predetermined number of clusters of nano structures having a number of atoms less than a predetermined number of atoms of transition metal and keeping the hydrogen in contact with clusters and heating of the primary reaction material in the initial process temperature, which is higher than the critical temperature, in particular, by creating a primary gradient in row material, as well as the dissociation of mentioned hydrogen H2 and formation of H— ions, as a consequence of the heating step, of subsequent impact impulse on the primary material for orbital reaction of capture of H— ions by nano structures cluster, resulting impact impulse stage in the capture of H— ions by atoms clusters, generating thermal capacity as the primary heat of this reaction, followed by removal of the part of heat energy, while keeping the temperature of the primary material to a temperature above the critical value, at which the main feature of the method is, that the quantity of secondary material is ensured, the number of secondary material is located in front of the base material and within a predetermined maximum distance from a primary material, a secondary material is adapted to interaction with protons emitting proton-dependent nuclear reaction with primary material, that take place with the release of additional heat in the form of secondary reaction of release of the heat. Thus, the step of removing heat energy comprises heat energy generated in the primary reaction (Q 1) and in the secondary reaction of heat release (Q 2).

Another feature of the present invention is to provide a device for implementing of these methods and such generators, which can reliably and accurately control the power generated by the generator.

In particular, the base material comprises nickel. Predetermined maximum distance between the primary material and the secondary material is about 7.5 cm. In this case, protons activated by nickel can reach the energy of about 6.7 MeV and in the presence of a hydrogen pressure of from 150 to 800 mbar absolute pressure can vary at most a distance of above 7.5 cm to decay into atomic hydrogen H— from the surface of the core, on which are the primary clusters of the reaction material.

The secondary material, adapted to interact with protons, includes lithium in predetermined fractions—⁶Li and ⁷Li isotopes and Boron in predetermined fractions of isotopes ¹⁰B and ¹¹B. Furthermore, as alternative is preferred the using of radioactive materials, such as materials of four groups of transuranic metals, as secondary material, i.e. ²³²Th, ²³⁶U, ²³⁹U, ²³⁹Pu, that provides further energy recovery. These transition metals cause repetitive energetic reactions in devices according to the patent.

Secondary material comprises at least one metal in the amorphous state as a crystalline ordered structure or comprises a plurality of metal alloy, particularly an alloy in amorphous state. For example, the alloy may consist of: Sc, Ti, V, Cr, Mn, Fe, Co, Cu, Ni, Zr, Pd, Ag, Cd, Mo, Au, Pt, Li, Be, B, Mg, Al, Si, P, Ca, K, as well as from the group of rare earth metals.

Another feature of the present invention is to provide the variants of devices for implementation of such methods and generators, which can reliably and accurately adjust the power generated by such devices according to the patent. In terms of the present invention, the generator contains a controller controlling the generated heat, comprising means of regulation of the amount of secondary material, which faces the primary material, and which is located within the maximum distance.

Thus, for implementing the method in a variant implementation of the device, screen housing includes a shield, disposed the primary and secondary material, a shield body with a possibility of movement between a first position of maximum exposure and a second position of minimum exposure.

This solution enables, depending on the temperature in the reaction chamber, with the control of position of shield, to regulate the output thermal power of the device.

The disadvantage of such a device includes the use of transuranic materials, difficulty of implementation and controlling of real devices.

Development of technology of devices generating the thermal energy by using of nuclear synthesis became possible with usage of the heat generators of company INDUSTRIAL HEAT, LLC. US. In the patent application of this company are submitted device and its variants. Application for Patent US2015016897 (WO2015127263) 27 Aug. 2015, ENERGY-PRODUCING REACTION DEVICES, SYSTEMS AND RELATED METHODS No of international application: PCT/US2015/016897. Applicant: INDUSTRIAL HEAT LLC US, Inventors: Andrea Rossi and Thomas Barker Dameron. U.S. Provisional Application Ser. No. 61/943,016, filed Feb. 21, 2014, and U.S. Provisional Application Ser. No. 62/060,215, filed Oct. 6, 2014

The reactor device, in accordance with the application form includes: reaction chamber; one or more heating elements in thermal contact with the reaction chamber configured with possibility to transfer thermal energy to the reaction chamber; and a refractory layer between the reaction chamber and the one or more heating elements.

Furthermore, the additional variants of devices are presented, differing by the presence of the refractory layer, or the presence of one or more heating elements, consisting from resistive wires, by the powering the heating elements by direct or alternating current, including three-phase AC, by the presence of special configuration of the refractory layer comprising a waive or ribbed surface, which increase the heat transfer of reaction chamber. Special attention of the inventors is given to the construction of reaction chamber, realized as a cylinder, surrounded by heating elements, which are in contact with the reaction chamber for transferring heat energy into reaction chamber, the chamber may be sealed by sealing elements, as well as the chamber may be equipped by temperature sensors to control the heat output of one or more heating elements responsive to the temperature, measured by the temperature sensor.

The amount of emitted heat in the reactor during a period, in which the device of functional reactor excludes chemical reaction, consists in the base of its working with a reactive material, used in the experiments. It underscores the fact, that the power of reactor is significantly higher than that of traditional energy sources.

The reactive material for generating of excessive heat includes lithium and nickel, which has a natural abundance of isotopic composition before starting reaction, but after 32 days of working of the device, the isotopic composition has been changed both on the lithium and a nickel. Such a change can occur by means of nuclear reactions only. It explains that nuclear reaction occurred outside of the combustion process.

Generally, the device generates the heat, which is compatible with the level of nuclear transformation with an appropriate reactive material, and it works on relatively low power and does not produce any radioactive nuclear waste or does not emit any radioactive radiation. Experimental test results show, that heat generating is above the level of chemical burning, and that the reactive material is subjected to nuclear transformation. It is shown that the device has a great potential and could be useful source of heat energy. Estimated coefficient of the consumed electric energy to heat energy output in watts reached COP=3.13±8%

The disadvantages of the device are the lack of variants of devices for practical use, as well as the presence of an electrical heating element with a low reactivity and lack of objective temperature control of the course of reaction in the mass of reactive material.

The greatest progress in the development of methods of nuclear reactions with the release of abnormal thermal power reached, due to extensive research, scientific and practical work on creating of reactors and systems with their implementation, Italian engineer Andrea Rossi. The practical applications of his research are implemented in the following patents. For example the patent of the United States Patent Application 2011000550

### Method and Apparatus for Carrying out Nickel and Hydrogen Exothermal Reaction

Current CPC Class: C01B 3/00 20130101; C01B 6/02 20130101; G21B 3/002 20,130,101; Y02E 60/324 20130101. International Class: F24J 1/00 20060101 F24J001/00

Method and device for obtaining the exothermal reaction of nickel and hydrogen.

Method and devices for carrying out the highly efficient exothermal reaction between the nickel and hydrogen atoms, preferentially in a tube, but not necessarily in a metal tube, containing nickel powder and heated to a high temperature, preferably from 150° C. to 500° C. Developed device contains the hydrogen, which is injected into the metallic tube, containing a highly pressurized nickel powder, under the pressure, preferably, from 2 to 20 bars.

According to the author of patents opinion, during the exothermal reaction are nucleus of Hydrogen, due to their high absorption capacity by nickel, fused with the nuclei of metal atoms, while said earlier, the high temperature creates internuclear interaction, which are amplified by the catalytic effect of additional elements, thereby causing a proton capture by nickel powder, followed by conversion of nickel to copper and conversion beta+decay, furthermore, the nickel core will have an atomic weight of one unit higher than the starting nickel.

According to the patent, the device contains the tube as a reaction chamber, in which the elements of reaction material—a nickel powder and an electric heater are placed, and the solenoid valve controlling the pressure and volume of hydrogen supplied into the reaction chamber is connected to the tube.

The temperature, which can be controlled by electrical power suppling, and the amount of supplied hydrogen allows to ensure the necessary control of the process taking place in the reaction chamber with the release of thermal energy that can be discharged into a heat exchanger with a circulating fluid. Doses of hydrogen are suitable to supply under varying pressure, and an electric heater is good to switch off periodically during the setting of reaction temperature controlled by a thermostat, providing automatic operation of such a reactor. Presented reactor is, according to the author opinion, device for the implementation of cold nuclear fusion or LTNR in a certain terminology.

The composition of the fuel mixture in the reactor, described in the patent, is stated in a form of granules of nickel flakes in nano crystalline state, in which the maximum absorption of the hydrogen atoms by nickel nuclei is possible.

The disadvantages of the device according to the patent are the limitations, associated with purchasing of the heat energy by means of heat exchange and with using of the thermostat, which is switching off the external heating when the hydrogen activates the nickel in the reaction chamber. Temperature measurement is not performed directly in the zone of location of the fuel mixture, but directly on the shell of the reactor, which leads to sintering of nickel nano powder and interrupting the reactor.

There are also known devices working on the principle of stimulation of the catalytic exothermic reaction of nano powder of nickel and chemical compound LiAlH₄—Lithium aluminum hydride by the external heat treatment generated by heating device of resistive type.

There are technical solutions, methods, devices and systems for commercial use of thermal energy obtained by catalytic reaction of crystalline powder of nickel and lithium aluminum hydride (LiAlH₄).

In accordance with the patent Fluid heater—U.S. Pat. No. 9,115,913, Rossi Andrea Sep. 25, 2015 Current CPC Class: F24J 1/00 (20130101), Current International Class: F24J 1/00 20060101) is submitted the device for liquid heating and a heater, which uses the electrical resistance heating element as an activator of the reaction of heat release in reaction mixture consisting of activated crystalline powder of nickel and lithium aluminum hydride (LiAlH₄). The patent also states that lithium aluminum hydride is used only to provide the exothermic reaction between lithium and hydrogen atom by using of hydrogen gas, catalyzed with nickel by activation with temperature, in which hydrogen release occurs actively. In this case, the heater is made as a plate and is in a direct contact with other plates on both sides thereof, which contain mentioned fuel mixture. The heating of liquid occurs so that the heating plates arranged in a tank with heated liquid that have direct contact for heat exchange. The device also includes a liquid temperature sensor, a voltage source and the controller to control the heater by changing the voltage that is supplied to the heater. Used effect is based on an exothermic reaction between lithium and hydrogen, which is subjected to catalytic reaction with nickel, or any other element of the tenth group of the periodic table of elements, including platinum and palladium. Effect of the reaction belongs to processes with a high-density of produced energy arising from the exothermic process, used in Andrea Rossi invention, and which according to the author refers to LENR reactions,

Said device is not without drawbacks, because the process of activation of the heater and the control over its work is performed by checking the heating temperature of the circulating liquid and the heating element itself has a large inertia and is located outside the zone of location of the fuel mixture.

### Energy Generation Apparatus and Method

### United States Patent Application 20150187444 Jul. 2, 2015

Current CPC Class: G21B 3/00 20130101; G21B 3/002 20130101 International Class: G21B 3/00 20060101 G21B003/00, Applicant: Brillouin Energy Corp. Inventors: Godes; Robert E.

Closest to the realization of practical implementation of nuclear fusion technology in the generating thermal energy for commercial use is the realization of Brillouin Energy Corp. In the Patent Equipment Energy Generator and Method are considered the theoretical and practical aspects of the reactor system for generating thermal energy and control devices, providing control of nuclear reactions process in the reaction material by controlling the activation energy supply and by controlling the energy release process of the device.

The patent presents a practical method of initialization and control of the synthesis of nuclei in a metal grid in realized devices. The reactor includes a download source for the emission of light nuclei, which should be involved in the synthesis, crystal lattice, which can absorb light nuclei, the source of energy of the phonons and a controller to start and stop stimulation of the phonon energy and/or reagents. Lattice transmits enough energy to phonons in order to influence the contact electron-core. By controlling the stimulation energy of the phonons and by controlling of light nuclei filling into the lattice, the energy released in the fission reaction is maintained at a certain level, so as to dissipate part of it even before it leads to destruction of the reaction lattice.

The patent describes the construction of several devices and methods for generating thermal energy in combination with their controlling.

In variants of the devices according to the patent, the basic principles of controlling nuclear fusion are implemented, at which, according to the methods, the variants of the reaction chamber are realized, comprising a case, a core of reactive material, a substance, capable to distribute phonons; a mechanism for introducing reagents into the zone; a mechanism for inducing phonons into the core, so that upon introduction of reagents into the reaction zone undergo a nuclear reactions; and a control system, coupled to the mechanism for introducing the reagents and to said mechanism for inducing phonons, to control the number of nuclear reactions and depth of nuclear reaction in said core, so as to ensure the required level of power production, allowing to dissipate energy generated during the nuclear reaction in such a way that avoid substantial destruction of this core. Variants of the device have differences, for example, reagents are added from the liquid medium, which in itself also acts as a heat transfer medium to remove heat from said core, optionally, the reagents can be added from the gaseous medium; and the device further comprises a thermally conductive solid material that is thermally connected to said reactor for removing heat, a variant, in which the mechanism for stimulating phonons includes in particular acoustic or ultrasonic source, or comprises a source of current pulses, and the reactor core is made as a wire or sheet, or the core is formed in pseudo-liquefied layer, or in a the form of nano powder, or mechanism for controlling the introduction of reagents into the reactor core comprises an electric field generator.

Such a reactor allows to implement the enhanced methods for stimulating of nuclear fusion reactions and methods for control reactions, in which the formation of the phonons in the reactor comprises heating the core, or assumes surge current penetrating of pulsed current through the fuel core containing the fuel reagents. The patent is of practical importance and variations of devices may be implemented in the form of commercial devices, however, have an external hydrogen source, which limits their use as separate and safe equipment for wide application.

### Technical Problems and Functioning Analysis of the Analogues and the Prototype

As implied by the analysis of the known devices published in the aforementioned patents, the main difficulty of the implementation of the devices based on LENR technology is associated with the control of the temperature within the reaction zone and with the control of the process of the temperature stabilisation in the vicinity of the critical point value, at which the metal catalyst melts and the nuclear synthesis process is interrupted. First of all, this is caused by the scheme of the heating process implementation that is in principle secondary, since the heating with the use of an external electric heater is sufficiently sustainable and the heater is usually structured as a resistance heating spiral wound on a tubular element, inside which the reaction material is placed. Similarly, the process of controlling temperature by means of a temperature sensor placed on the surface of the tubular element of by any other means described in the patents cannot ensure precise maintenance of the temperature value within the reaction zone any analyse the process of launching the melting phase of the catalyst metal. These methods do not provide information on the start of the catalyst melting process or of any other methods of temperature measuring that are described in the aforementioned patents.

The construction of the known reactor devices according to the LENR technology uses, as the initiation devices, electric heating elements equipped with regulators of the thermal energy supply within the reaction zone operating on the principle of changing the level of voltage or current, as well as pulse width power supply modulators. There are also other constructions of heat generation devices known, using hydrocarbon sources, such as ethanol, natural gas, light liquid hydrocarbons: gasoline, diesel oil, vegetable oil, hydrogen-oxygen mixtures, plasma heating sources. Nonetheless, due to the complex construction of the reactors with the closed reaction zone, there are to this date no known implemented methods and devices of reactors based on the LENR technology using any other sources of thermal energy other than electric energy, which significantly limits the practical use, in particular in the case of autonomous use, such as in road transport or in island systems of energy generation. However, the examples of implementation of the known methods and devices based on the LENR technology do not provide any information regarding the possibility to regulate the output performance of the reactors, apart from temporary interruption of the nuclear analysis by means of disconnecting the initiation thermal energy supply and by means of disconnecting the heating device of the reaction chamber. There are certain methods known where the control of the LENR reaction output within the reaction zone is triggered by external impulse impacts of various physical nature at the start of the reactor's activity and upon repeated initiations.

### SUBSTANCE OF THE INVENTION

In the materials submitted with respect to the claimed patent, the heater is structured as a porous ceramic electrically conductive tubular element made of a high-temperature ceramic and a reaction material containing a metallic catalyst powder, such as nickel (Ni), and a fuel mixture containing the chemical elements lithium (li) and hydrogen (H), proportionally distributed inside the pores. In the course of the initiation and operation, the inner surface is being heated and the thermal energy is being removed from the outer surface, with metal contacts connected to the control system input being placed at the opposite ends. For the purpose of electric resistance control at the heater, these contacts are subjected to voltage and the current value is being measured, and the first and/or second derivative of the current is being calculated for the control process, based on which the temperature is determined at which the LENR process occurs and this temperature is being maintained by means of disconnecting or connecting the thermal energy supply to the heater and to the reaction material within the range minus (5-10%) of the initial melting temperature of the catalyst, for which purpose the appropriate control devices are connected to the control system output.

Alternative of the heater constructed as a porous ceramic electrically conductive tubular element made of high-temperature withstanding ceramic, the composition of which contains a catalyst metal powder, such as nickel (Ni), and a fuel mixture containing the chemical elements lithium (Li) and hydrogen (H), proportionally distributed inside the pores.

Alternative where the heater is receiving thermal energy during combustion of hydrocarbon fuels, such as combustion gas, in the course of the impact on the outer surface and the thermal energy is being removed from its inner surface.

Alternative where the heater can receive thermal energy by means of being subjected to electric current guided through metal contacts from the control system for the purpose of electric resistance control at the heater, for which purpose they are subjected to voltage and the current value is being measured, and the first and/or second derivative of the current is being calculated for the control process, based on which the optimum temperature is determined at which the LENR process occurs and this temperature is being maintained by means of disconnecting or connecting the thermal energy supply to the heater and to the reaction material within the range minus (5-10%) of the initial melting temperature of the catalyst, for which purpose the current is being regulated within the porous ceramic electrically conductive tubular element.

The expansion of the possibilities of use of the heater thanks to the reverse utilisation of the inner and outer surfaces by means of changing their purpose as the surfaces for the initiation heating or for the thermal energy removal, as applicable.

Constant temperature measuring and continuous control of the process of energy release in the fuel mixture with direct regulation of temperature within the zone of the LENR reaction.

In all construction alternatives of different methods and devices pursuant to the submitted patent, the temperature of the reaction material heating in the porous body of the ceramic electrically conductive heater is being continuously measured during the operation of the heater and the control system determines the reaction point i.e. the point of disconnection of the supply of the external thermal energy into the system, as well as the point of re-commencing the thermal energy supply, during fluctuations of the temperature in the vicinity of the catalyst melting point that can be determined as the Debye temperature.

The resistance is being controlled as a consequence of a change of the electric current flowing through the heater during its measuring. In the course of the current measuring process, constant voltage is being supplied to the heater and the current is being measured. A sharp increase of the current value and its first and second derivations represent a typical parameter of LENR processes in the fuel mixture distributed in the porous ceramic electrically conductive element. Such a change of the current is characteristic for exceeding the Debye temperature in the fuel mixture and for the creation of melting zones of the catalyst crystalline powder, which eventually results in the interruption of the LENR reaction. The control system assists in the calculation of the current value for the current state and in defining the compliance of its value with the standard temperature value. If the current value exceeds the permissible value, or if it is increasing at a rate or with an acceleration exceeding the standard, then it is obvious that the metal catalyst is being melted. The system responds by means of reducing the level of heat impact on the heater, while maintaining its operation mode within the pre-determined temperature range, calculated for the given type of the heater and its operation modes. The universal construction of the heater is adapted for the use of hydrocarbon sources of heat initiation or electric energy.

The composed construction of the heater and the heating devices, where additional thermal energy is being obtained and the efficiency is being increased through the use of a ceramic electrically conductive element with a reaction material placed in its pores, constructed as two electrically insulated coaxial cylindrical bodies constituting the initiation heater and the emission heater; the initiation heater receives external heating energy and heats the emission heater, with the produced thermal energy being removed from the outer surface of the emission heater. Metal contact outputs are placed on the opposite ends of the heater, connected to the input of the control system for controlling the electric resistance in the heaters, for which purpose they are subjected to voltage and the current value is being measured, and the first and/or second derivative of the current is being calculated, based on which the temperature is determined at which the LENR process occurs and this temperature is being maintained by means of disconnecting or connecting the thermal energy supply to the heaters and the reaction material within the range minus (5-10%) of the initial melting temperature of the catalyst, for which purpose the thermal energy connection/disconnection control devices are connected to the control system output.

Multi-sectional heaters and heating devices where the initiation heater and the emission heater are divided into two or more (three or four) sections with the aim of achieving smooth control of the output power, which enables ensuring continuous regulation of the generated thermal output. These possibilities provide a theoretical basis for the construction of compact and mobile sources of heat production with the minimal electricity consumption.

The convection tubular electric. heater with a vertical heat-conductive panel, on which a two-lamella radiator is fixed, with the developed surface where the tubular element is placed at an angle of 15°-25° and where the heating device (including multi-sectional) is hermetically fixed by means of the screw thread connection at the lower part of the tubular element, with the other end being hermetically sealed, and with the inside of the tubular element being filled with a liquid with the boiling point between 95° C. and 115° C. up to the level covering the surface of the heating device. Another possible alternative is the convection tubular electric heater containing a four-lamella radiator.

Such convection tubular electric heaters have characteristic properties represented by the use of heating devices with porous ceramic coverage of the surface of the thermal emission. When these devices are used, preferentially in a tubular element at an angle of 15° -25° to the horizontal plane, with the surface being covered by a small water layer, the heating results, due to the porous coverage, in the increased release of steam bubbles. The distribution of steam in the inner area of the tubular heater causes its fast and efficient heating. As the heat passes from the surface of the lamellae of the tubular heater, the heater gets cooled and water steam is subsequently condensed inside the surface of the tubular unit, accompanied with liquefaction and subsequent return of the liquid to the surface of the heating device. This principle of functioning is much more efficient compared to a common electrical heater.

The liquid heating systems with the possibility of the output regulation by means of different alternatives of the heating devices of accumulation and flow-through type, with the use of hydrocarbon energy sources or electric energy sources, enable obtaining of highly efficient heating devices with minimum costs for the generation of heat and with the utilisation of the thermal energy from the combustion of hydrocarbon fuels, it is possible to extend the scope of the utilisation of LENR devices.

The universal microcomputer-based control system enables to control the temperature level inside the reaction material of the heater and to manage the heating devices within the set of various flow-through and accumulation systems for the heating of liquids, as well as convection systems, where the LENR process is utilised, and maintain the temperature by means of disconnecting or connecting the thermal energy supply to the reaction material within the range of minus (5 to 10%) of the initial melting temperature of the catalyst forming a part of the reaction material.

### Solution of Technical Problems Through the Use of the Invention

The declared methods and alternatives of the device enable, with the use of the heaters, the implementation of various schemes of use in liquid and air heating systems. The proposed methods, devices and their alternatives, as well as the technical solutions, are free of any drawbacks present in any known reactor devices utilising the LENR technology.

The devices according to this patent are implemented in compliance with the methods and presented as: heaters, heating devices, heating systems and control system.

The main element , the heater is structured as a porous ceramic electrically conductive tubular element, cylinder, made of a high-temperature withstanding electrically conductive porous ceramic and a reaction material containing a metallic catalyst powder, such as nickel (Ni), and a fuel mixture containing the chemical elements lithium (Li) and hydrogen (H), proportionally distributed inside the pores. Or alternative of the heater, in which a porous ceramic electrically conductive tubular element, made of a high-temperature withstanding ceramic contains a catalyst metal powder, such as nickel (Ni), and a fuel mixture containing the chemical elements hydrogen (H) and lithium (Li) is proportionally distributed inside the pores. Metal contact outputs are placed on the opposite ends of the heater, connected to the input of the control system. For the purpose of electric resistance control at the heater, and subsequently of control of the temperature level inside the reaction material of the heater these contacts are subjected to voltage and the current value is being measured, and the first and/or second derivative of the current is being calculated for the control process, based on which the temperature is determined at which the LENR process occurs and this temperature is being maintained by means of disconnecting or connecting the thermal energy supply to the heater and to the reaction material within the range minus (5-10%) of the initial melting temperature of the catalyst, for which purpose the appropriate control devices are connected to the control system output. Such structure of the heater guarantees constant control of the temperature within the reaction zone.

A specific element of the given method of thermal energy production and of the heater construction for the implementation of this method is the use of the ceramic electrically conductive porous heater that was not known in the past, where the reaction material is distributed, allowing in the different methods for active control and regulation of the nuclear fusion process within the reaction zone on the basis of the main characteristic aspect, i.e. the electric resistance, measured during the operation—in the course of the measuring and calculating the speed or acceleration (first or second derivation) of the value of the current passing through the heater, which is a function of the internal temperature of the ceramic heater at which the LENR reaction takes place.

The significant extension of the control method of the LENR reaction lies in the combination of the reaction material heating in the porous body of the ceramic electrically conductive heater with the simultaneous continuous temperature measuring and determination by the control system of the reaction point—i.e. the point of disconnection of the supply of the external thermal energy into the system, as well as the point of re-commencing the thermal energy supply when the temperature decreases.

The heating devices are capable of stable generation of thermal output as a result of permanent monitoring of temperature during the energy release process in the fuel mixture by means of direct measuring of the electric resistance within the zone where the nuclear fusion reaction in the heater takes place. The heating devices and their alternatives can be used in all. known facilities for thermal energy production—accumulation and flow-through liquid heating systems, in high efficiency (COP) convection heaters with the possibility of the output regulation,

COP (coefficient of performance)−the ratio of the generated heat and the consumed energy.

Efficiency—multi-functional factor of the ratio between the input energy consumed on the heat initiation and the output thermal energy generated by the device as a result of the LENR reaction.

For example, the COP heat factor value for the heaters using the LENR technology in the patent application US2015016897 (WO2015127263) dated 27 Aug. 2015 ENERGY-PRODUCING REACTION DEVICES, SYSTEMS AND RELATED METHODS is specified as=3,13±8%, referring to the consumed electric energy to the output thermal energy (heat performance) in watts.

The calculation coefficient of COP factor for the alternatives of heating devices containing an initiation heater that receives external thermal energy of the heating and an emission heater, structured as two electrically insulated coaxial cylindrical bodies, can have the calculation multiplied coefficient COP at the level of 9.7969±8%, which also extends the scope of utilisation of the devices constructed pursuant to this patent.

In order to increase efficiency (COP) the alternative of the heating device is implemented that consists of an initiation heater that receives external thermal energy by means of electric voltage supply or by means of combustion of hydrocarbon fuel, such as combustion gas, and of an emission heater constructed as two electrically insulated coaxial cylindrical bodies; alternative of the heating device comprising an initiation heater divided into two, three or four sections, each of which has metal contacts connected to the control system, receiving external thermal energy of the heating, and an emission heater divided into two, three or four sections, each of which has metal contacts connected to the control system, constructed as two electrically insulated coaxial cylindrical bodies; alternative of the heating device in which the initiation heater receives the external thermal energy by means of combustion of hydrocarbon fuel, such as combustion gas, through two, three or four burners and the inner surface of the emission heater creates a flow chamber and its end exit sleeves are equipped with screw threads for the connection of the sockets for the supply and removal of the heated liquid (heating media); alternative of the heating device in which the sections of the initiation heater receive the external thermal energy of the heating by means of electric supply and the inner surface of the emission heater creates a flow chamber and its end exit sleeves are equipped with screw threads for the connection of the sockets for the supply and removal of the heated liquid (heating media); alternative of the heating device where the metal case is covered by porous ceramic material and equipped with a screw thread for its mounting.

The use of such heating devices enables significant savings of the thermal energy needed for the initiation of the operation of the devices, as well as smooth regulation of the generated thermal output.

All construction alternatives of the heaters have metal contacts on the opposite ends, connected to electric conductors made of high-temperature withstanding metal, for example of known alloys of nickel and chrome; similarly, in the heating devices and their alternatives, the ends of the initiation heater and of the emission heater are connected at one side and share a single common terminal, with the electric conductors on the other side being guided out through the ceramic insulation insert in the area of the flange or the screw thread connection.

For the purpose of extending the practical utilisation, different alternatives of the heaters and heating devices are adapted for the use of known hydrocarbon sources of thermal energy or of electric energy, with minimum energy consumption for the known category of heat generation devices.

The utilisation of the electric energy impact for thermal initiation enables the heating devices fast launching of the LENR reaction in the fuel mixture, taking into consideration the short time of heating of the porous ceramic electrically conductive element, which enables minimising the costs of the energy consumption and the use of such devices in various mobile systems of heat generation with low energy consumption.

The universal control system based on a microcomputer (microcontroller) enables to control the temperature level inside the reaction material of the heater and to manage the heating devices within the set of various flow-through and accumulation systems for the heating of liquids, where the LENR process takes place, and maintain the temperature by means of disconnecting or connecting the thermal energy supply to the reaction material within the range of minus (5 to 10%) of the initial melting temperature of the catalyst. It also enables to control the temperature of the heated liquid at the input and at the output of the heating system and the thermal stabilisation of the determined parameters. The microcomputer-based control system contains computer communication interfaces for the connection of external computer devices, temperature sensors, liquid flow meters, heating devices, various alternatives, hydrocarbon burners and is to the maximum extent adapted to the functional processes of the heating devices that operate based on the principle of controlled LENR reactions in the fuel mixture.

The declared methods and alternatives of the devices enable, with the use of the specified heating devices, the utilisation of various systems of warming and heating with the use of liquids and air.

### Description of the Possibilities and Novelty of the Invention

The implementation of the methods and devices and their alternatives represents the possibilities of the invention and the areas of its use in line with this patent.

The heating device in accordance with the methods contains a heater, structured as a porous ceramic electrically conductive tubular element made of a high-temperature withstanding ceramic and a reaction material containing a metallic catalyst powder, such as nickel (Ni), and a fuel mixture containing the chemical elements lithium (Li) and hydrogen (H), proportionally distributed inside the pores in a ratio ranging between 10 and 80% of the surface of the ceramic heater pores, as well as the alternative of the heater, in which a porous ceramic electrically conductive tubular element made of a high-temperature withstanding ceramic contains a catalyst metal powder, such as nickel (Ni), and a fuel mixture containing the chemical elements lithium (Li) and hydrogen (H) is proportionally distributed inside the heater pores, metal contact outputs are placed on the opposite ends of the heater. The heaters are placed in a hermetically sealed metal case made of high-temperature withstanding metal, preferentially a nickel (Ni) alloy, equipped with a flange or the screw thread connection, at the lower part of flange the ceramic and electric insulation inserts are placed, used for guiding out the terminals of electric contacts. Hermetic case of the heater device ensures long-term storage of hydrogen (H) and increases the operating hours of the device according to the patent.

Such construction of the heater enables during the electric current supply to one side of the porous ceramic electrically conductive tubular element to heat the inner surface of the porous element and transmit the initiation heat to the reaction material. After the temperature reaches 150° C., the lithium aluminium hydride (LiAlH₄) distributed on the pores starts evaporating and being released to the bound hydrogen (H) that is dispersed all over the heating device.

After the temperature exceeds 500° C., the exothermic catalytic reaction is initiated on the surface of the catalyst in the form of nickel (Ni) powder and as a result of the reaction the released atomic hydrogen (H) can continue to participate in the reactions of nuclear fusion with lithium (Li) contained in the fuel mixture in accordance with the known reactions, up to the temperature of 1450° C.-1550° C., up to the melting point of the aluminium (Al) powder, in the vicinity of the Debye temperature determined for the given reaction material.

3LiAlH₄→Li₃AlH₆+2Al+3H₂

2Li₃AlH₆→6LiH+2Al+3H₂

2LiH+2Al→2LiAl+H₂

Another temperature increase above the nickel melting point is associated with the increase of the current level and the decrease of the resistance of the ceramic heater containing the fuel mixture, and acts as a signal of approximation to the critical point—the Debye temperature for the reaction material of the reactor, at which it is necessary to disconnect the thermal output supply to the zone of the LENR reaction. Upon the temperature decrease, atomic hydrogen recombines on the nickel surface into molecular hydrogen. Another temperature decrease to the level of re-connecting the resistance of the ceramic heater containing the fuel mixture within the scope exceeding 10% of the critical point level may constitute a signal for the control system to restart the energy supply to the zone of the LENR reaction.

The expected costs of the thermal energy from the reversible exothermic catalytic reaction of hydrogen molecules breakdown into atoms at the level of 20-40 kcal/mol (83-116 kJ/mol), and the subsequent recombination on the same nickel surface to the molecular hydrogen takes place with the release of energy of 104 kcal/mol (435 kJ/mol), which represents the energy output of 60-80 kcal/mol (250-335 kJ/mol). The speed of the course of the recombination reactions at the Debye temperature for the reaction material—catalyst, and the molecules of lithium aluminium hydride (LiAlH₄) in the fuel mixture reaches its maximum and the time can be t=10⁻⁸ seconds.

A. Rossi presumes additional thermal energy of the nuclear fusion of the lithium on the catalyst surface to be released during the reaction of the fuel mixture with the same composition of the reaction material. According to his theory, the proton of the hydrogen atom enters, through the quantum tunnel effect, the core of ⁷₃Li— (i.e. the core of lithium having the atomic weight of 7), thus creating the core ⁸₄Be— (i.e. the core of beryllium having the atomic weight of 8), and then breaks down in the course of several seconds into two alpha particles (helium cores), which is accompanied with the release of a significant amount of nuclear energy.

⁷₃Liᵣ+p→⁸₄Be₄→2α(17.25 MeV)

The reaction material used in all the alternatives of the heaters and heating devices contains 70% of nickel powder where the grain fineness is primarily within the range of 2-10 microns and 30% of the fuel mixture—lithium aluminium hydride (LiAlH₄) where the grain fineness is primarily within the range of 10-100 microns. The aggregate weight of the reaction material is preferentially 1 gram. The porous material of the heater ensures high diffusion of hydrogen on the surface of the catalyst in the reaction material and the grain fineness of the reagents ensures high coverage and filling of the surface of the pores of the ceramic heater, which guarantees even distribution of the fuel mixture on the surface of the pores, thus ensuring increased reactivity of the reaction material.

The Debye temperature of the reaction material represents a characteristic energy parameter of the state of the system of collective interactions of the substance atoms at which all atoms and molecules of different substances participate in the aforementioned LENR reactions inside the pores of the heater, up to the melting point of the amorphous catalyst powder, as an extremely high-temperature withstanding material. The calculation of this temperature is difficult, since different components are in different aggregate states, with different energy levels of collective interaction. Nonetheless, its value can be determined on the basis of the characteristic parameter of temperature in the vicinity of the Debye temperature, at which the specific physical component occurs—the change of the electric resistance of the reaction material and of the porous electrically conductive ceramic material of the heater, to the detriment of a sharp decrease of resistance and increase of current, with the recorded change of the electric resistance of the nickel-based catalyst itself, which indicates that the temperature of nickel crystals melting has been reached inside the pores of the heater. The speed of the resistance change—first derivation dl/dt, or of the acceleration—second derivation d″I/dt², represent measurable and controllable physical values of the process of approximation of the characteristic parameter of temperature to the critical point of the catalyst melting. The symbol i designates the recordable current value in the heater.

The control system is constructed for the purpose of controlling the changes of the current parameters in the heaters by means of measuring the value of the current flowing through the heater upon its initiation by thermal impact, both from the outside, for example while receiving thermal energy from the burner, as well as during the voltage supply for heating.

In a typified heating device, the electric energy consumption can be 300 W, with the equivalent output thermal performance of 900 W with the reaction material weight of 1 gram. In a heating device of the type of heating system, with the power supply of 300 W, on the initiation heater, the thermal output generated on the emission heater can reach 2700 W with the reaction material weight of 4 grams.

The alternatives of the device—heaters and heating devices adapted for the use of hydrocarbon sources of heat initiation or electric energy.

The heating devices are capable of controlling the generated thermal output and temperature during the energy release process in the fuel mixture by means of direct temperature control within the zone where the nuclear fusion reaction in the heater takes place.

The universal control system based on a microcomputer enables to control the temperature level inside the reaction material of the heater and to manage the heating devices of various accumulation and flow-through systems for the heating of liquids, as well as convection heaters, where the LENR process takes place, and maintain the temperature by means of disconnecting or connecting the thermal energy supply to the heater and the reaction material within the range of minus (5 to 10%) of the initial melting temperature of the catalyst.

### OVERVIEW OF FIGURES OF THE DRAWINGS

The basic element of the patent—heater 1—operates as the device for the implementation of the method pursuant to claim 1.

FIG. 1a represents the construction of the heater 1 constructed as a porous ceramic electrically conductive tubular element, comprising metallic contacts 2 of the upper part of the heater and metallic contacts 3 of the lower part of the heater, constructed for the connection (by means of soldering or welding) to the terminal 4 of the upper contact with a metal conductor to the terminal 5 of the lower contact with a metal conductor.

FIG. 1b represents the heating device. The inner surface 7 of the heating device and the case 10 of the heating device are constructed as cylindrical bodies, made preferentially of a nickel (Ni) alloy, covering the surfaces of the heater 1 both inside and outside, and these surfaces are at the same time the direct surfaces of the thermal energy receipt and of the emission of the thermal energy produced, depending on the specific construction alternative and methods of the heat initiation of the given heating device.

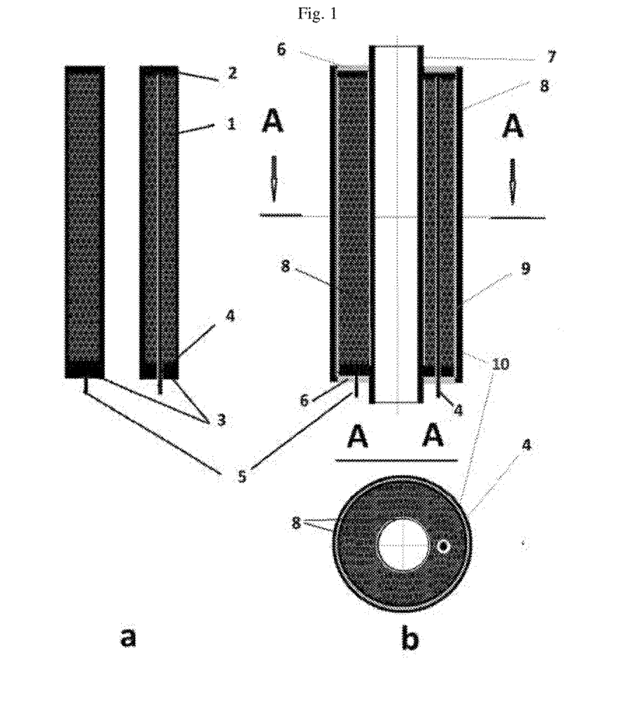

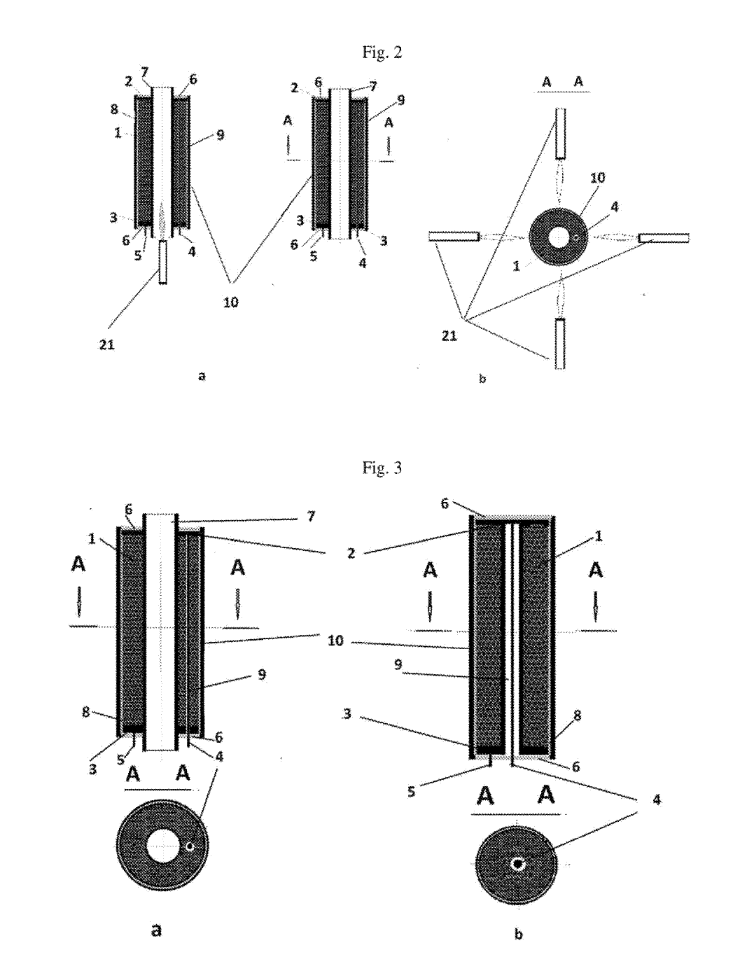

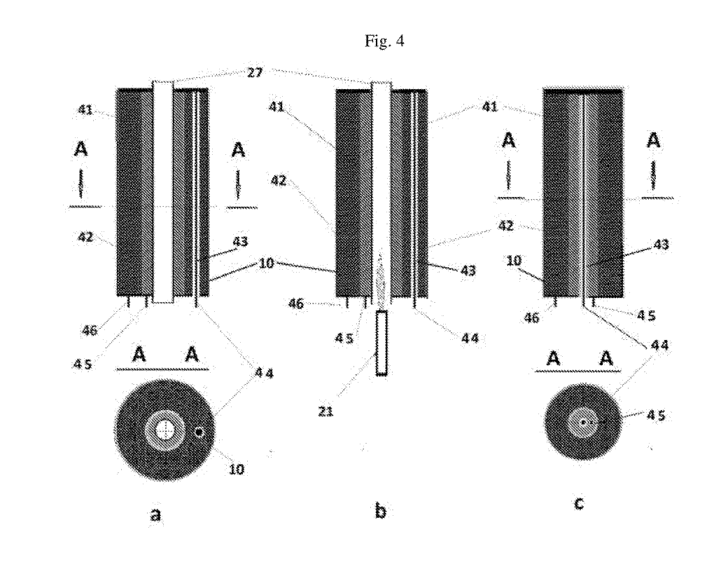

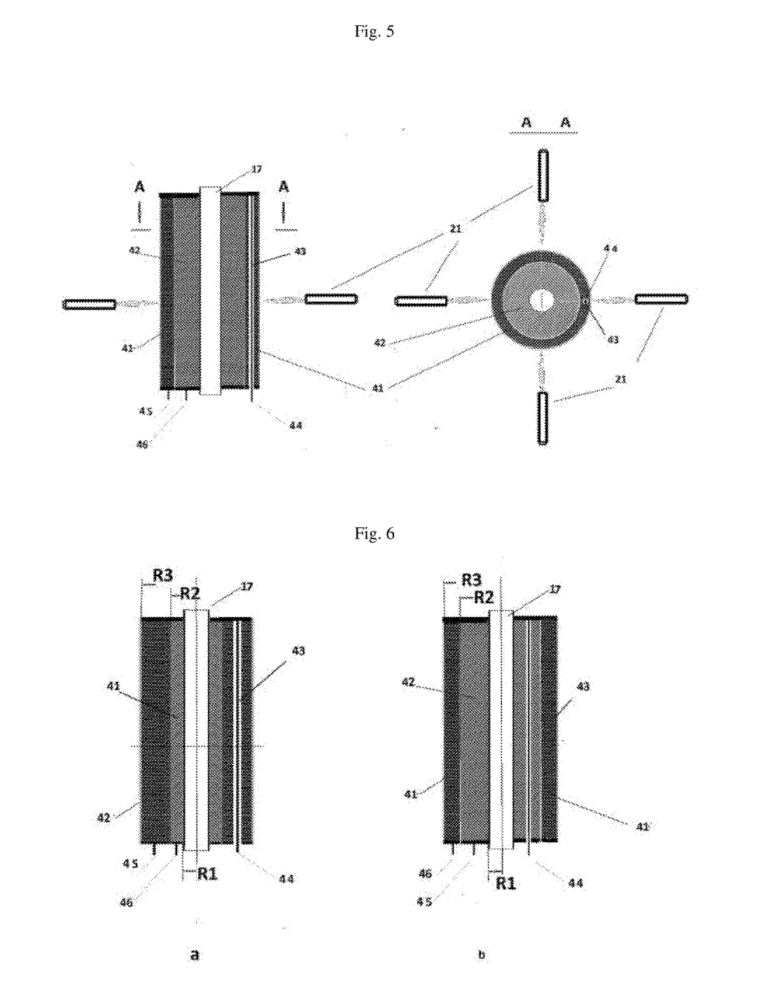

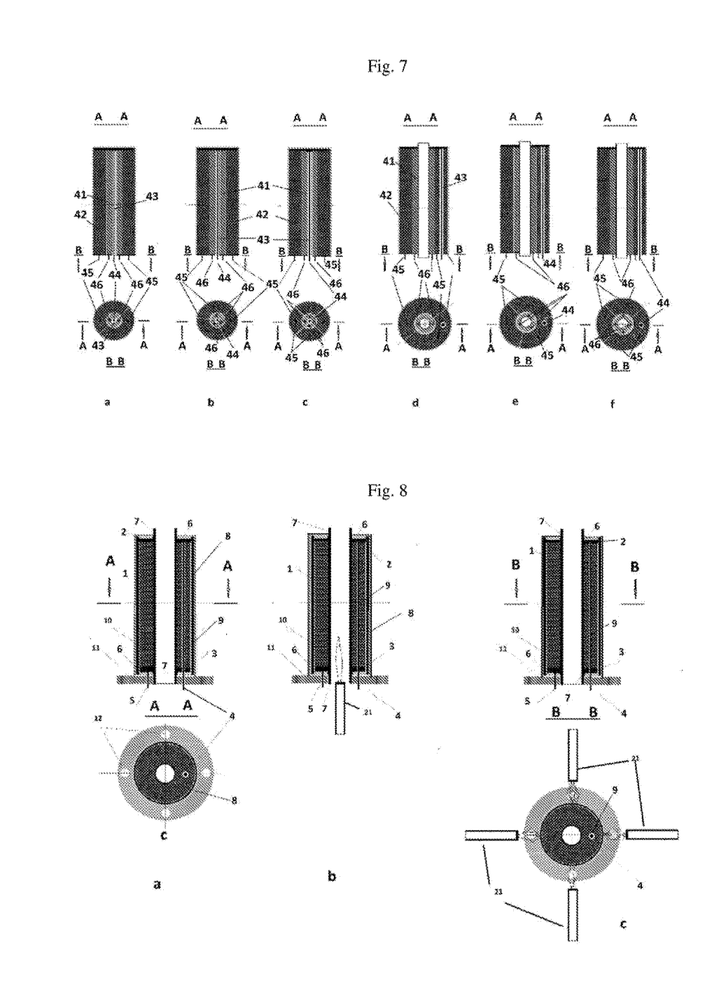

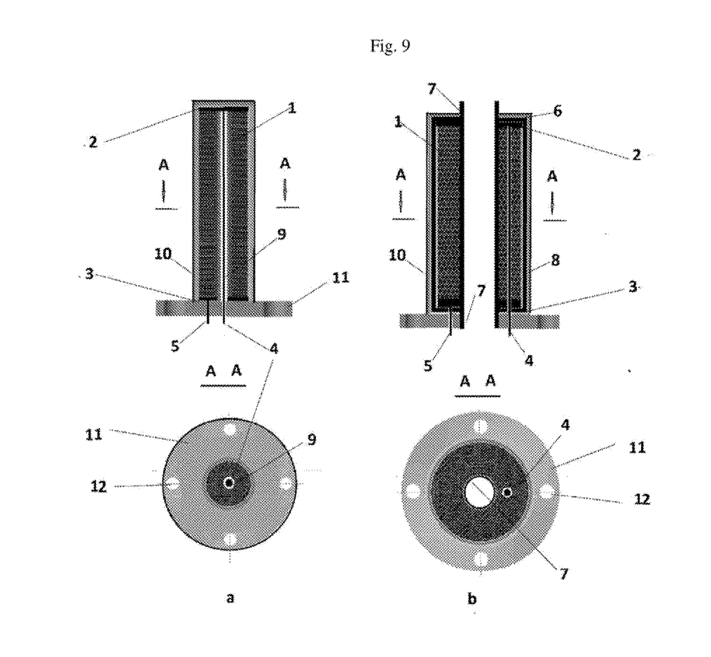

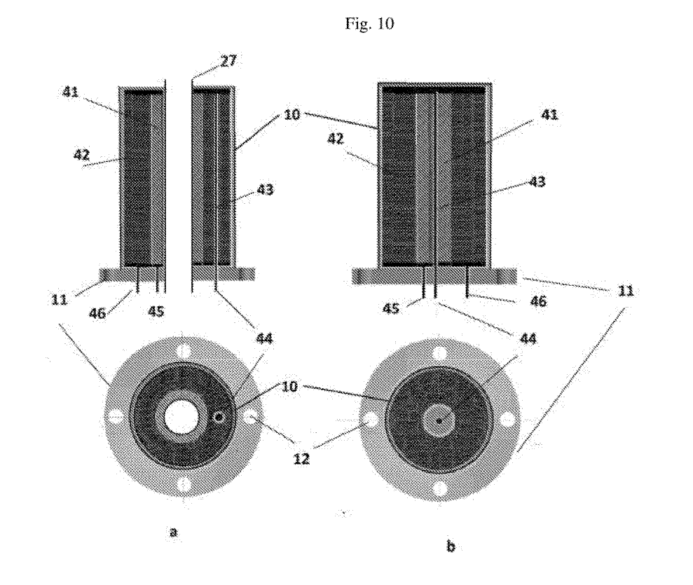

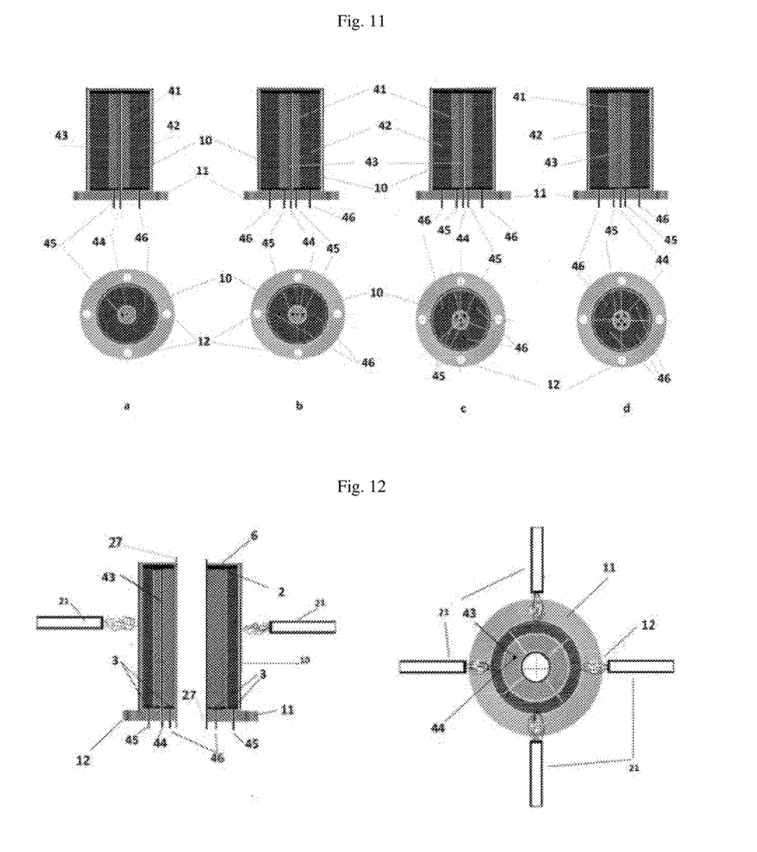

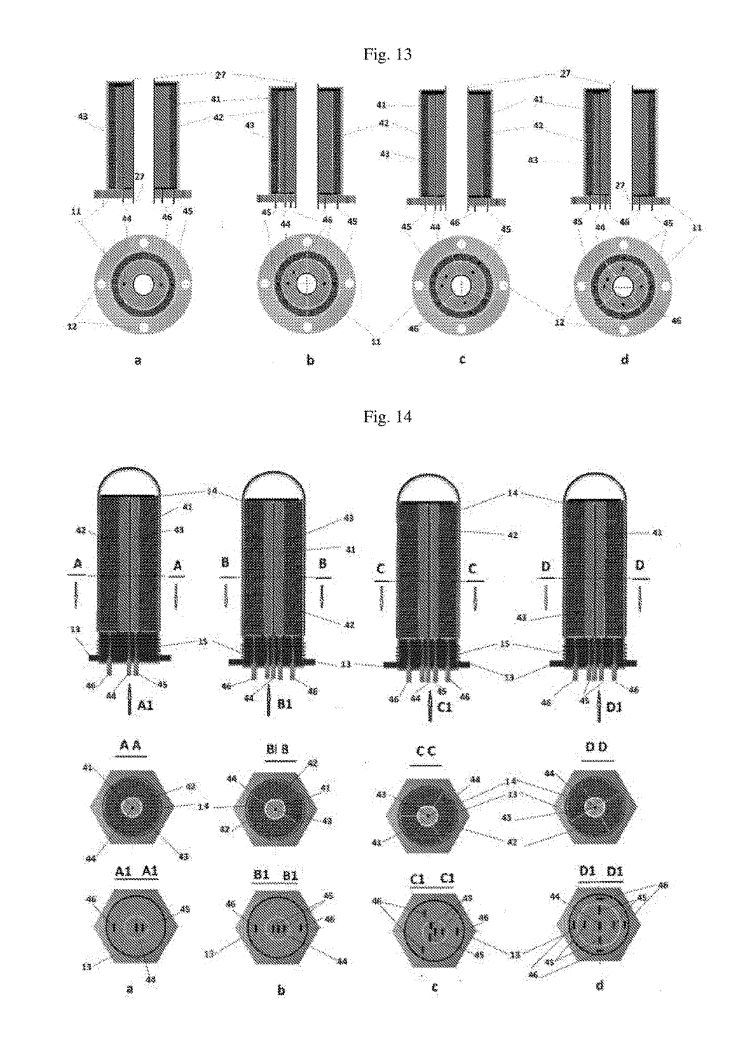

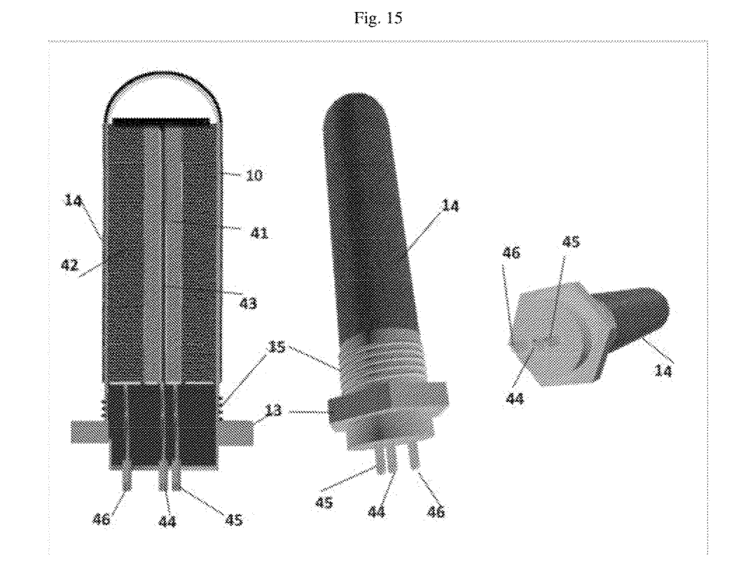

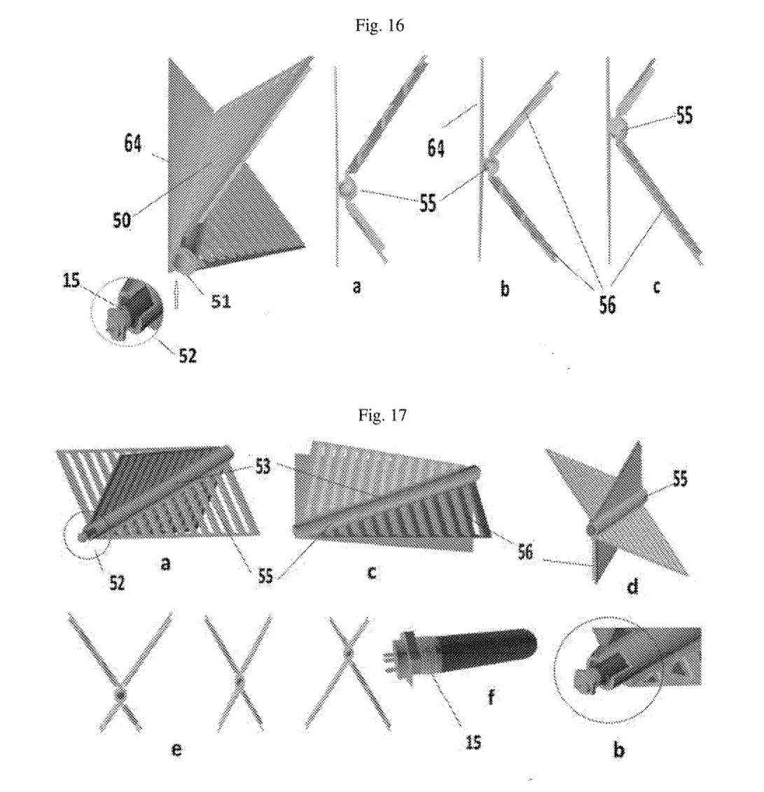

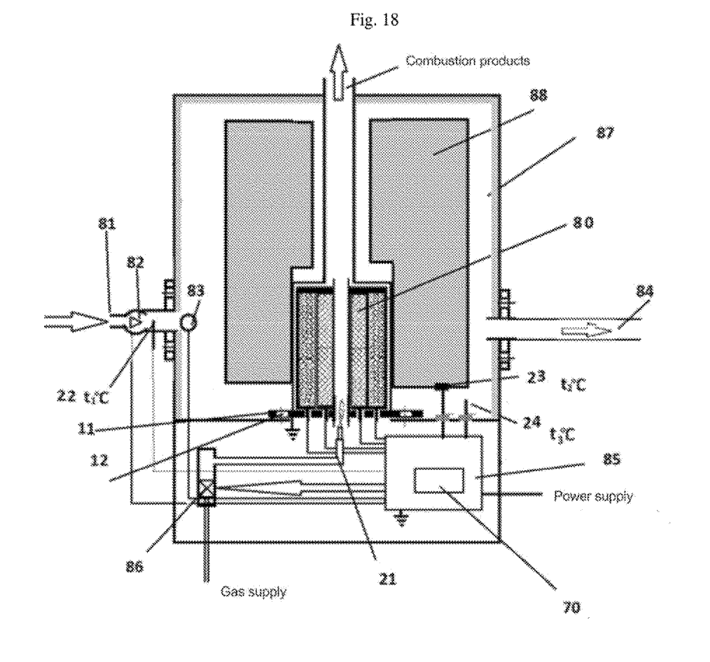

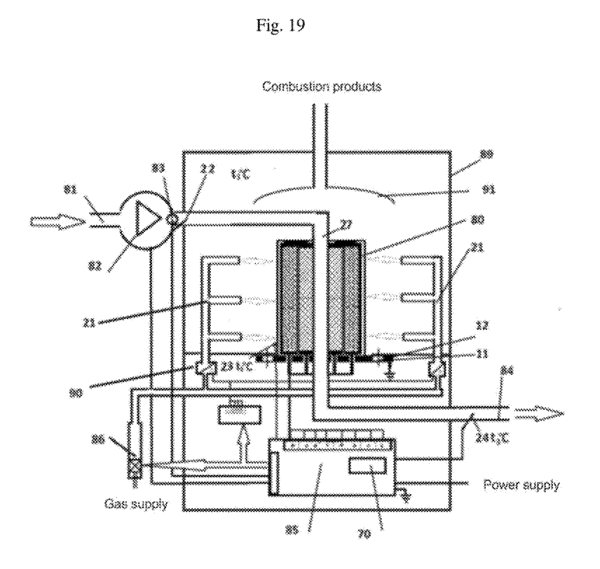

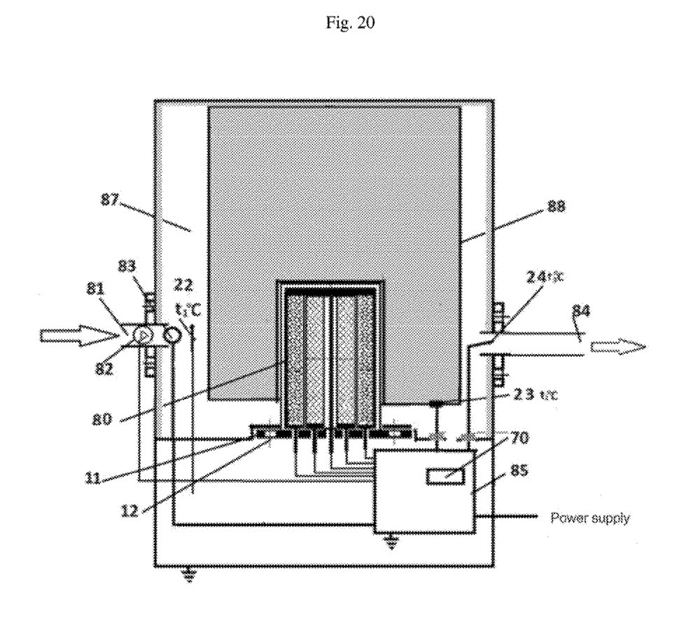

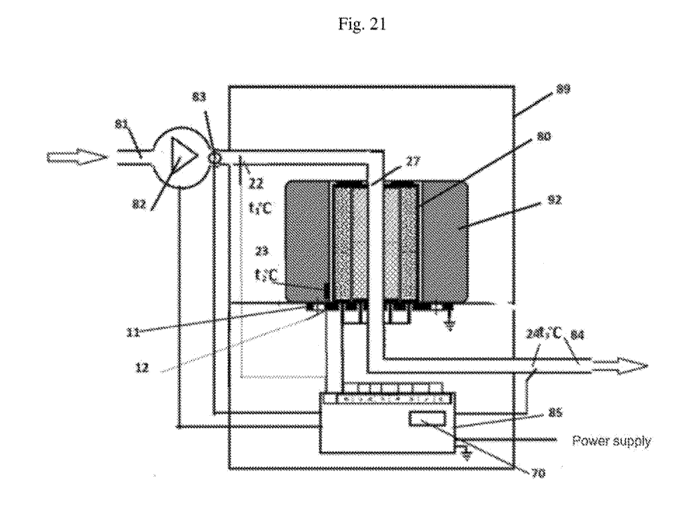

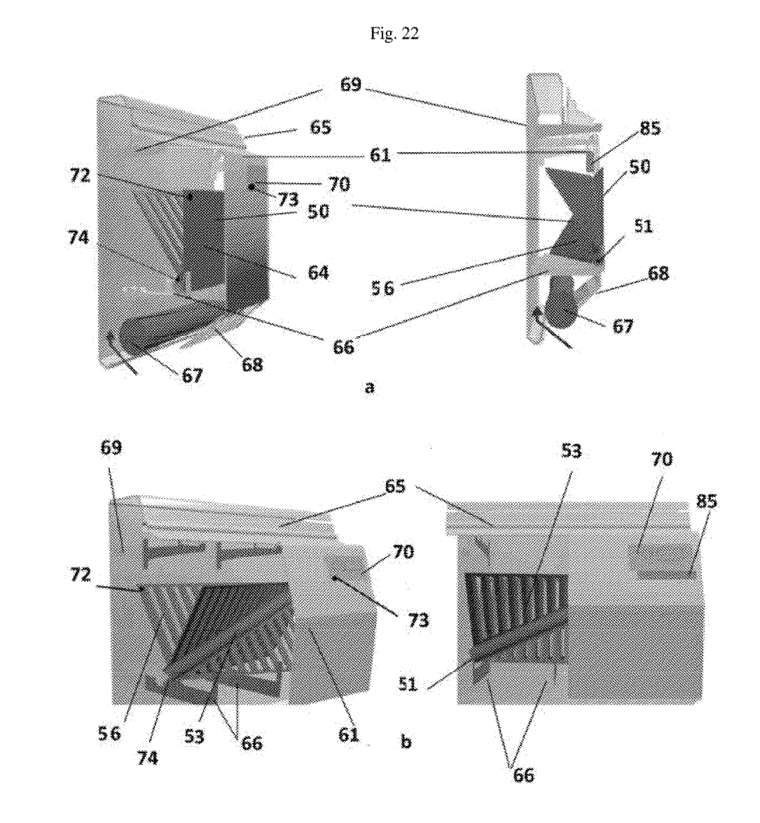

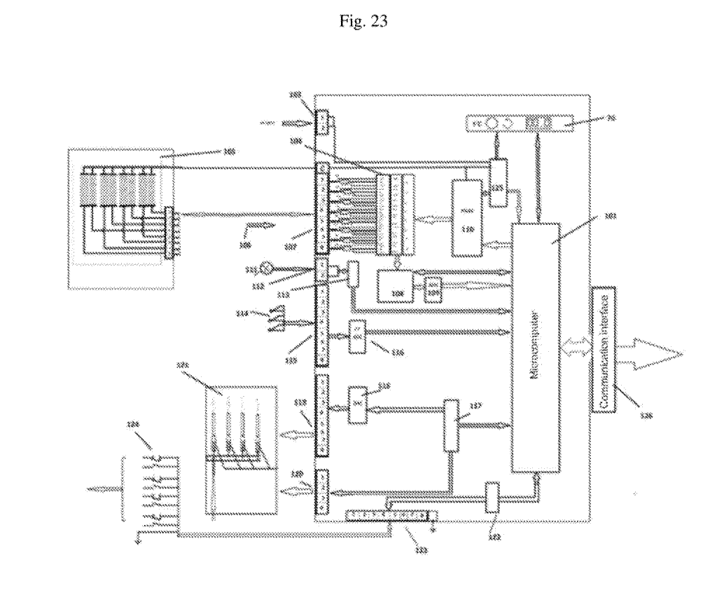

At the end surfaces of the heating device, there are ceramic insulation inserts 6 placed at the upper and lower part, used for guiding out the terminals of electric contacts.

The inner surface 7 of the heating device equipped with screw threads is used for the receipt of external thermal energy or for the transmission of the generated thermal energy and the screw threads can be used for the connection of water pipes or of the burner. The heater 1 is insulated by electric insulation 8 from the metal parts of the case 10 of the heating device. Channel 9 in the heater in the form of an opening going through the metal conductor made of high-temperature withstanding metal, such as an alloy of nickel (Ni) and chrome (Cr), is used for guiding out to the terminal 4 of the upper contact with a metal conductor that is electrically insulated from the sides of the heater 1.

FIG. 2 represents an example of the heating device structure with the use of hydrocarbon fuel, such as fuel gas, and a heating device with the use of a burner.

Alternatives of the implementation of the external initiation of the heater depending on the particular alternative: a—heating of the inner surface 7 of the heating device; and b—heating of the outer surface of the heating device from four sides.

The heater 1 constructed as a porous ceramic electrically conductive tubular element, contains metal contacts 2 of the upper part of the heater and metal contacts 3 of the lower part of the heater, and also terminal 4 of the upper contact with the metal conductor and terminal 5 of the lower contact with the metal conductor and ceramic insulation inserts 6. The channel 9 in the heater is used for guiding out the terminal 4 of the upper part with the metal conductor. The inner surface 7 of the heating device and the case 10 of the heating device are equipped with electric insulation 8. The burner 21 of hydrocarbon fuel, for example fuel gas, can be used for the heating of the inner surface 7 of the heating device equipped with screw threads for its connection, or for the heating of the outer surface of the case 10 of the heating device ensuring the supply of initiating thermal energy, depending on the scheme of use of the heater 1.

As indicated by the figure, in case of heating of the inner surface 7 of the heating device, the thermal energy can be collected from the outer surface of the case 10 of the heating device, and in the other way, in case of supply of initiating thermal energy on outer surface of the case 10 of the thermal device, the thermal energy can be removed from the inner surface 7 of the heating device for implementation, for example, the flow heater liquid equipment by connecting water pipe to the screw threads on the inner surface 7 of the heating device.

FIG. 3 represents various alternatives of heating devices constructed pursuant to the methods of claims 4, 11 and 12.

a—Heating device receiving thermal energy from the electric current, where thermal energy is being removed from the outer surface or from the inner surface.

b—Heating device receiving thermal energy from the electric current, where thermal energy is being removed from the outer surface.

Inside the hermetic case 10 of the heating device, there is a heater 1, constructed as a porous ceramic electrically conductive element, containing a reaction material inside its pores.

In this construction alternative of the heating device, thermal initialisation is performed by means of subjecting the metallic contacts 2 of the upper part of the heater and metallic contacts 3 of the lower part of the heater to electric current passing through these contacts. The reaction material is distributed in the pores of the heater 1 and after the heating to the initialisation temperature of the LENR reaction, additional thermal energy starts to be released. Depending on the particular alternative of the heating device used, thermal energy can be collected from the inner surface 7 of the heating device or from the surface of the case 10 of the heating device.

The construction alternatives of the heating devices differ in that with the method pursuant to claim 11 the heater 1, constructed as a porous ceramic electrically conductive tubular element is made of a high-temperature withstanding ceramic containing a mixture of powders SiC, ZrO₂, Al₂O₃ and carbon (C) powder, and a reaction material containing a metallic catalyst powder in the form of metal powder of the elements of the 10th group of the Periodic Table, in particular nickel (Ni), and a fuel mixture, proportionally distributed inside the pores in a ratio ranging between 10 and 80% of the surface of the ceramic pores, with metallic contacts 2 of the upper part of the heater and metallic contacts 3 of the lower part of the heater being placed at the opposite ends, to which electric conductors made of high-temperature withstanding metal are connected, i.e. the terminal 4 of the upper contact with a metal conductor and the terminal 5 of the lower contact with a metal conductor. At the end surfaces of the heating device, there are ceramic insulation inserts 6 placed at the upper and lower part, used for sealing and thermal insulation. Channel 9 is installed in the heater 1 for guiding the upper contact made of high-temperature withholding metal to the terminal 4 of the upper contact with a metal conductor.

Alternative implementation of the method of claim 12 differs in that, the heater 1, constructed as a porous ceramic electrically conductive tubular element is made of high-temperature withstanding ceramic, the composition of which already contains a catalyst metal powder, such as nickel (Ni), and a fuel mixture, containing the chemical elements lithium (Li) and hydrogen (H), is proportionally distributed inside the pores.

FIG. 4 represents different alternatives of the implementation of the methods and devices using: a—composed porous ceramic electrically conductive tubular element, in the pores of which a reaction material is distributed, structured as two electrically insulated coaxial cylindrical bodies forming the initiation heater 41 and the emission heater 42. The initiation heater 41 receives the external heating energy, for example from the hydrocarbon fuel burner 21, and heats the emission heater 42 through the inner surface 27 of the composed heating device, removing the produced thermal energy from the outer surface of the emission heater 42. Metal contacts are placed at the opposite ends of the heaters: the terminal 45 of the initiation heater, the terminal 46 of the emission heater, and the terminal 44 of the common contact. The common contact from the upper part is guided to the lower part of the heating device through the channel 43 for guiding out the common contact to the terminal.

FIG. 4b—The initiation heater 41 receives thermal energy from the combustion of hydrocarbon fuel, such as combustion gas, from the hydrocarbon fuel burner 21.

FIG. 4c—The initiation heater 41 receives thermal energy from the terminals of metal contacts through which the electric current passes.

The figure shows that the volumes of the initiation heater 41 and of the emission heater 42 are different, that their ratio is 1:3 and that the ratio of the wall thickness of the initiation heater 41 and of the emission heater 42, with the inside layout of the initiation heater 41, is lower than or equal to (4 R₂−3 R₁), in accordance with the method pursuant to claim 9.

FIG. 5 illustrates the composed heater in accordance with the method pursuant to claim 8, comprising the initiation heater 41, placed at the outside of the emission heater 42, where the initiation thermal energy is being supplied from the burner 21 for hydrocarbon fuel directly to the outer surface. The thermal energy is being collected from the inner surface 17 of the composed heater, equipped with screw threads used for the connection of sockets, for example for heating of liquids. The composed heater further contains the contact terminals: terminal 45 of the initiation heater, terminal 46 of the emission heater and terminal 44 of the common contact. The common contact is guided to the terminal through the channel 43. The volumes of the initiation heater 41 and of the emission heater 42 are different, their ratio is 1:3 and the ratio of the wall thickness of the initiation heater 41 and of the emission heater 42, with the inside layout of the initiation heater 41, is bigger than or equal to (4 R₂−3 R₁), in accordance with the method pursuant to claim 9.

FIG. 6. As illustrated in the preceding FIGS. 4 and 5, the volume ratio of the cylindrical coaxial bodies comprising the initiation heater 41 and the emission heater 42 is 1:3, and subject to the condition of equal height, the ratio of the wall thickness of the initiation heater 41 and the emission heater 42 is ≤3 with the internal supply of thermal energy and ≥1/3 with the external supply of thermal energy.

H_{IT}—the thickness of the wall of the initiation heater 41 is defined as (R₃−R₂),
H_{IT}—the thickness of the wall of the emission heater 42 is defined as (R₂−R₁),
where:
R₃—maximum radius of the outer heater,
R₂—maximum radius of the inner heater,
R₁—radius of the inner surface of the inner heater.

Alternative a, where the initiation heater 41 is inside and the emission heater 42 is outside.

(R₃, R₂)≤3(R₂−R₁) or R₃≤4 R₂−3 R₁,

Alternative b, where the initiation heater 41 is outside and the emission heater 42 is inside.

(R₃, R₂)≥−1/3 (R₂−R₁) or R₃>4/3 R₂−1/3 R₁.

Such ratio of volumes of the heaters enables to ensure, with the supply of the initial thermal energy, the guaranteed mode of operation of the initiation heater 41 needed for the thermal energy supply to the emission heater 42 and the operation in line with the method pursuant to claim 5 so that sufficient thermal energy is obtained and so that the efficiency of the composed heater and of the heating device is increased, with the possibility of controlling the operation modes of the heater.

FIG. 6 represents the recommendation for the construction alternatives of composed heaters of placing the terminal 44 of the common contact in the emission heater 42 that has a larger volume than the initiation heater 41. Similarly, the terminal 45 of the initiation heater and terminal 46 of the emission heater belong to the initiation heater 41 and to the emission heater 42, irrespective of the specific construction of the composed heater that also contains the inner surface 17 of the composed heater.

FIG. 7 represents the alternatives of the sectional structure of the heaters in line with the method pursuant to claim 10, where the initiation heater 41 and the emission heater 42 are divided into two, three or four sections, which allows for continuous regulation of the output performance of the composed heater.

According to the method pursuant to claim 13—Alternative 1. The initiation heater 41 receives the heating electric energy from the inside, the emission heater 42 receives if from the outside, in the following construction alternatives: a—Heater divided into two sections; b—Heater divided into three sections; c—Heater divided into four sections.

According to the method pursuant to claim 5—Alternative 2. The initiation heater 41 receives thermal heating energy from the burner, for example from the inside, the emission heater 42 from the outside, in the following construction alternatives: d—The heater is divided into two sections. FIG. 7 further represents channel 43 of guiding the common contact to the terminal, terminal 44 of the common contact, terminal 45 of the initiation heater from the sections of the initiation heater and terminal 46 of the emission heater from the sections of the emission heater.

All alternatives of these constructions of composed heaters count with the possibility, in order to accelerate the achievement of the parameters of the thermal energy production upon starting the LENR reaction and consequently the operation of the device in compliance with claim 13, to receive at the initial moment the thermal energy by the initiation heater 41 or emission heater 42 or their sections by means of the electric current passage through these heaters or their sections through the metal contacts: terminal 45 of the initiation heater, terminal 46 of the emission heater and terminal 44 of the common contact. The common contact is guided to the terminal through the channel 43.

FIG. 8 represents the alternatives of the heating device pursuant to claims 14 and 15. In general, the heating device contains a heater 1 structured as a porous ceramic electrically conductive tubular element with metallic contacts 2 of the upper part of the heater and metallic contacts 3 of the lower part of the heater, terminal 4 of the upper contact with a metal conductor and terminal 5 of the lower contact with a metal conductor; for the purpose of sealing, thermal insulation and electric insulation, there are ceramic insulation inserts 6 placed at the ends, between the inner surface 7 of the heating device and the case 10 of the heating device. The electric insulation 8 is serves for insulating the heater 1 from the case 10 of the heating device. The channel 9 in the heater for guiding the contact to the terminal is used for the terminal 4 of the upper contact with a metal conductor. It also contains a flange 11 of the heating device base, including openings 12 in the flange used for the fixation of the heating device. The heating device may receive the initiating external thermal energy from the burners 21 of hydrocarbon fuel, for example fuel gas. The burners are placed at the outside, evenly distributed, for example at four sides.

The heating device according to the method pursuant to claim 4, as illustrated in FIG. 9, can be functionally implemented for the operation by means of the initiation thermal energy supply from the electric current passing through the heater.

a—Heating device pursuant to claim 16; b—Heating device pursuant to claim 17.

In general, the heating device contains: a heater 1 structured as a porous ceramic electrically conductive tubular element with metallic contacts 2 of the upper part of the heater and metallic contacts 3 of the lower part of the heater, terminal 4 of the upper contact with a metal conductor and terminal 5 of the lower contact with a metal conductor and ceramic insulation insert 6. For the purpose of connecting pipes for the liquid supply in the case of using the flow-through heating system, the inner surface 7 of the heating device is equipped with screw threads. It is further equipped with a channel 9 in the heater, electric insulation 8 used for insulation and a case 10 of the heating device, from which it is possible to collect thermal energy in the case of using the accumulation system of liquid heating. It also contains a flange 11 of the heating device base, including openings 12 in the flange used for the fixation of the heating device to various systems used for heating of liquids.

FIG. 10 represents the alternatives of the heating device of composed (combined) type, implemented according to the manner pursuant to claim 5, receiving energy at the outer case 10 of the heating device, usable in accumulation systems for heating liquids.

a—Heating device pursuant to claim 18, flow-through type, with the outside heating using hydrocarbon fuel, or with electric heating; b—Heating device pursuant to claim 19, with electric source of heating. The heating devices contain the following basic parts: inner surface 7 of the heating device equipped with screw threads, case 10 of the heating device, flange 11 of the heating device base, including openings 12 in the flange used for the fixation of the heating device, initiation heater 41, emission heater 42, channel 43 of guiding the common contact to the terminal. For their connection to the control system, they further contain: terminal 44 of the common contact, terminal 45 of the initiation heater from the sections of the initiation heater and terminal 46 of the emission heater from the sections of the emission heater.

FIG. 11 represents the alternatives of the construction of heating devices pursuant to claim 20. The heating device is implemented based on the following layout principle: initiation heater 41 inside, emission heater 42 outside, with the electric heating in the following construction alternatives: a—Heating device; b—Heating device divided into two sections. All heating devices in the alternatives specified above contain the following parts: case 10 of the heating device, flange 11 of the heating device base, including openings 12 in the flange used for the fixing of the heating device. For example, the device of alternative d contains four groups of contact terminals from the sections of the initiation heater 41 and of the emission heater 42 and one terminal 44 of the common contact. Such sectional layout of the heater enables obtaining the maximum or proportional part of the maximum output thermal energy (thermal output) from the heating device.

FIG. 12 represents possible construction of the heating device pursuant to claim 21. It is an example of using a 4-sectional heating device with an external source of thermal energy for flow-through heaters with the heating of the outside case 10 of the heating device by four gas burners, with the possibility of continuous regulation of the output performance, obtained from the inner surface 27 of the composed heating device for flow-through heating of liquids. The heating device in this particular layout contains the following parts: metallic contacts 2 of the upper part of the sections of the composed heater, metallic contacts 3 of the lower part of the sections of the composed heater, ceramic insulation inserts 6, case 10 of the heating device, inner surface 27 of the composed heating device, flange 11 of the heating device base, including openings 12 in the flange used for the fixing of the heating device, burners 21 for hydrocarbon fuel, for example combustion gas, the number of which depends on the number of the heating device sections, initiation heater 41, emission heater 42, channel 43 of guiding the common contact to the terminal, terminal 44 of the common contact, terminal 45 of the initiation heater, terminal 46 of the emission heater. During the operation of the heating device structured as a flow-through system for the heating of liquids, the thermal initiation takes place for example on the outer surface of the heating device, from four burners ensuring the initiation thermal energy supply to the relevant sections of the initiation heater 41. The produced thermal energy is collected from the inner surface of the emission heater 42 by means of the liquid flow. The pipes with the liquid are connected by means of screw threads located at the ends of the inner cylindrical surface 27 of the composed heating device.

FIG. 13 represents the construction of heating devices pursuant to claim 22 of flow-through type, with electric heating in different alternatives of construction. It is an example of the construction of the heating device and various alternatives of 2-, 3- and 4-sectional heating device with electric source of thermal energy for flow-through heaters with sectional heating and with the possibility of continuous regulation of the output performance, obtained from the inner surface 27 of the composed heating device for flow-through heating of liquids. The alternatives of the heating devices have the following section layout: a—Heating device; b—Heating device divided into two sections.

The heating device in this particular layout contains the following parts: inner surface 27 of the composed heating device, flange 11 of the heating device base, including openings 12 in the flange used for the fixing of the heating device, initiation heater 41, emission heater 42, channel 43 of guiding the common contact to the terminal, terminal 44 of the common contact, terminal 45 of the initiation heater, terminal 46 of the emission heater.

During the operation of the heating device structured as a flow-through system for the heating of liquids, the thermal initiation takes place for example on the outer surface of initiation heater 41, which is supplied with electrical energy, or its 2-, 3- or 4-sections are supplied, ensuring the initiation thermal energy supply to the sections of the initiation heater 41. The produced thermal energy is collected from the inner surface of the emission heater 42 by means of the liquid flow. The pipes with the liquid are connected by means of screw threads located at the ends of the inner cylindrical surface 27 of the composed heating device.

FIG. 14 represents the alternatives of the construction of heating devices pursuant to claim 23, using the case 14 covered by the porous ceramic material. It is an example of the construction of the heating device and various alternatives of 2-, 3- and 4-sectional heating device with electric source of thermal energy for accumulation heaters with the possibility of continuous regulation of the output performance, obtained from the external porous ceramic surface for accumulation systems for heating of liquids.

The alternatives of the heating devices have the following section layout: a—Heating device; b—Heating device divided into two sections. The heating device in this particular layout contains the following parts: flange 13 at the lower part of the heating device with an external screw thread, case 14 covered with porous ceramic material, initiation heater 41, emission heater 42, channel 43 of guiding the common contact to the terminal, terminal 44 of the common contact, terminal 45 of the initiation heater, terminal 46 of the emission heater. During the operation of the heating device structured as an accumulation system for the heating of liquids, the thermal initiation takes place for example on the surface of the initiation heater 41 to which electric energy is being supplied, or there are two, three or four sections supplied, that ensure the initiation thermal energy supply to the relevant sections of the initiation heater 41. The thermal energy obtained from the surface of the emission heater 42 is collected through the case 14 covered with porous ceramic material for further heating of the liquid volume, in which the heating device is placed. The porous surface initiates efficient evaporation in the pores of the ceramic material and ensures maximum heat transmission from the surface of the heating device through the created steam bubbles.

FIG. 15 represents the heating device pursuant to claim 16 that in this particular layout contains the following parts: flange 13 at the lower part of the heating device with an external screw thread, case 14 covered with porous ceramic material, screw thread connection 15, initiation heater 41, emission heater 42, channel 43 of guiding the common contact to the terminal, terminal 44 of the common contact, terminal 45 of the initiation heater, and terminal 46 of the emission heater.

During the operation of the heating device, the thermal initiation takes place in a volume of the initiation heater 41 to which electric energy is being supplied, that ensure the initiation thermal energy supply to the initiation heater 41. The thermal energy obtained from the surface of the emission heater 42 is collected through the case 14 covered with porous ceramic material for further heating of the liquid volume, in which the heating device is placed. The porous surface initiates efficient evaporation in the pores of the ceramic material and ensures maximum heat transmission from the surface of the heating device through the created steam bubbles.

FIG. 16 represents the construction of a convection tubular electric heater pursuant to claim 24 with the use of the heating device pursuant to claim 23. The convection tubular electric heater 50 with a vertical thermally conductive panel 64, on which a two-lamella radiator 56 is fixed, with the developed surface and an angle of 95°-110° between the lamellae, characterised by the fact that the tubular unit element 55 is placed on the vertical thermally conductive panel 64 at an angle of 15°-25° and that the heating device implemented pursuant to claim 23 is hermetically fixed to the screw thread connection 15 at the lower part of the tubular element at the connection mounting point 51 of the heating device inside the tubular heater of the aforementioned tubular unit element 55, the other end of which is hermetically sealed, and with the inside of the tubular unit element 55 being filled with a liquid with the boiling point between 95° C. and 115° C. up to the level covering the surface of the heating device. Marking of the elements in FIG. 16: a—cross section of the radiator at the beginning; b—cross section of the radiator in the middle; c—cross section of the radiator at the end. Additional represented elements: connection mounting point 51 of the heating device in the tubular heater, assembly position 52 of the heating device in the tubular heater, tubular unit element 55, radiator lamellae 56 with developed surface, vertical thermally conductive panel 64. The device operates with all types of heating devices constructed pursuant to claim 23. When using heating devices with two, three and four sections of the initiation heater 41, the produced thermal energy can be continuously regulated. Thus, the convection tubular electric heater can efficiently and with a wide output range operate as a heating unit in different types of convection radiators.

FIG. 17 represents the construction of a convection tubular electric heater pursuant to claim 25 with the use of the heating device pursuant to claim 23. The 4-lamella tubular heater 53 comprises a four-lamella radiator on which four lamella sections are fixed with an angle of 95°-110° between the lamellae, characterised by the fact that the tubular unit element 55 is placed at an angle of 15°-25° towards the lamellae and the heating device implemented pursuant to claim 23 is hermetically fixed to the screw thread connection 15 at the lower part of the tubular unit element 55, the other end of which is hermetically sealed, and with the inside of the tubular unit element 55 being filled with a liquid with the boiling point between 95° C. and 115° C. up to the level covering the surface of the heating device. The main components of the convection tubular electric heater: a—overall view of the 4-lamella tubular heater; b—drawing of the fixation of the heating device and its appearance—enlarged; c—side view of the 4-lamella tubular heater; d—bottom view of the 4-lamella tubular heater; e—cross sections of the 4-lamella tubular heater at the beginning, in the middle and at the end; f—heating device pursuant to claim 23. The device operates with all types of heating devices constructed pursuant to claim 23. When using heating devices with two, three and four sections of the initiation heater 41, the produced thermal energy can be continuously regulated. Thus, the convection tubular electric heater can efficiently and with a wide output range operate as a heating unit in different types of convection radiators.

FIG. 18 represents the heating system of accumulation type, used for heating of liquids with gas heating pursuant to claim 26. The liquid heating system of accumulation type, comprising a thermally insulated accumulation tank 87 filled with liquid, a socket 81 for the liquid supply and a socket 84 for the liquid removal, burner 21 with a closure valve 86 used for closing the supply of hydrocarbon fuel, a heating device constructed pursuant to claim 18, placed inside the cylindrical heat exchanger 88 equipped with radial plates, and an outlet channel of the combustion products, control system 85, to which the heating device 80 is connected, the flange 11 of the heating device base, including openings 12 in the flange for the connection of the heating device, temperature sensor 22 of the liquid at the input (t₁° C.), temperature sensor 24 of the liquid at the output (t₃° C.), and temperature sensor 23 of the liquid of heat exchanger surface (t2° C.). The control system 85 controls the fuel supply unit that controls the functioning of the burners and of the closure valve 86 when the values of the common operation are exceeded or when the liquid temperature exceeds 95° C. In addition, it contains an electronic temperature regulator 70 as a part of the control system 85 that determines the required values of the liquid heating temperature. The heating device is installed in a thermally insulated accumulation tank 87 in the direct contact with the heat exchanger 88, at the flange 11 of the heating device base equipped with openings 12 in the flange used for the fixation of the heating device for better heat transmission to the liquid. The liquid is being supplied to the thermally insulated accumulation tank 87 by means of the liquid supply pump 82 in which the liquid flow meter 83 is installed.

During operation of the device, the control system 85 receives data from the temperature sensors: liquid sensor temperature 22 at the input t₁° C., liquid sensor temperature 23 at the heat exchanger t₂° C. and liquid sensor temperature 24 at the output t₃° C.

FIG. 19 represents a heating system of flow-through type, used for heating of liquids with gas heating pursuant to claim 27. The liquid heating system of flow-through type, comprising the construction 89, a socket 81 for the liquid supply and a socket 84 for the liquid removal, connected with the heating device 80 by means of the screw threads at the inner surface 27 of the composed heating device, used for ensuring the heating of the liquid flowing through the inner area; in addition, it contains a burner 21 with a closure valve 86 connected to the supply of hydrocarbon fuel, a heating device 80 constructed pursuant to claim 21, placed inside the cylindrical heat exchanger 88 equipped with radial plates inside the construction 89, and an outlet channel of the combustion products—combustion products trap 91, control system 85, to which the heating device 80 is connected. Signals from the liquid sensor temperature 22 at the input t₁° C., from the liquid sensor temperature 24 at the output t₃° C. and from the temperature sensor 23 of the coat of the heating device t₂° C. are transmitted to the input of the control system 85. The control system 85 controls the fuel supply unit 90 of the burners that controls the functioning of the burners 21 and of the closure valve 86 that closes the supply of hydrocarbon fuel when the values of the common operation are exceeded or when the liquid temperature exceeds 95° C. In addition, it contains an electronic temperature regulator 70 as a part of the control system 85 that determines the required values of the liquid heating temperature. The heating device is installed in the construction 89 at the flange 11 of the heating device base equipped with openings 12 in the flange used for the fixation of the heating device. The liquid is being supplied to the device by means of the liquid supply pump 82 in which the liquid flow meter 83 is installed. For the purpose of more even heating of the outside surface of the heating device 80, the burners 21 for hydrocarbon fuel can be combined in the form of several burners per one heating sector, thus ensuring the necessary even distribution of the heat flow on the surface of the heating device. For the purpose of removing the combustion products, a combustion products trap 91 is planned to be installed inside the construction 89 of the liquid heating system, used for subsequent liquidation of the combustion products.

FIG. 20 represents the heating system of accumulation type, used for heating of liquids with the use of electric heating device pursuant to claim 28. The liquid heating system of accumulation type, with the possibility of continuous regulation of the heating performance comprises the following components: thermally insulated accumulation tank 87 filled with liquid, socket 81 for the liquid supply, socket 84 for the liquid removal, liquid supply pump 82, liquid flow meter 83, heating device 80 constructed pursuant to claims 16, 19 and 20, placed inside the cylindrical heat exchanger 88 with radial plates. The heating device is installed at the flange 11 of the heating device base, equipped with openings 12 in the flange used for the fixation of the heating device. The device further contains the control system 85 to which the heating device 80 is connected and the temperature sensors: liquid sensor temperature 22 at the input t₁° C. placed at the inlet socket 81 for the liquid supply, liquid sensor temperature 24 at the output t₃° C. placed at the socket 84 for the liquid removal and liquid sensor temperature 23 at the heat exchanger t₂° C. placed at the heat exchanger 88 in the vicinity of the heating device 80, the signals from which trigger the disconnection of the electrical energy supply when the values of the common operation are exceeded or when the liquid temperature exceeds 95° C. In addition, it contains an electronic temperature regulator 70 as a part of the control system 85 that determines the required values of the liquid heating temperature.

FIG. 21 represents the heating system of flow-through type, used for heating of liquids with the use of electric heating device pursuant to claim 29. The liquid heating system of flow-through type comprising the heating device 80 with screw threads at the inner surface 27 of the composed heating device to which socket 81 for the liquid supply and socket 84 for liquid removal are connected, and the thermal insulation 92. The heating device is installed in the construction 89 at the flange 11 of the heating device base equipped with openings 12 in the flange used for the fixation of the heating device. The flange 11 of the heating device base ensures safe connection of the heating device 80 and its easy dismounting. The device further contains the control system 85 to which the heating device 80 is connected and the temperature sensors: liquid sensor temperature 22 at the input t₁° C. placed at socket 81 for the liquid supply, liquid sensor temperature 24 at the output t₃° C. placed at socket 84 for the liquid removal and liquid sensor temperature 23 at the coat of the heating device (t₂° C.) placed at the external surface of the heating device 80, the signals from which, transmitted to the control system 85, trigger the disconnection of the electrical energy supply when the values of the common operation are exceeded or when the liquid temperature exceeds 95° C. In addition, it contains an electronic temperature regulator of the liquid supply pump 82 that regulates the speed of the heated liquid supply, with the installed liquid flow meter 83 and electronic temperature regulator 70 that determines the required values of the liquid heating temperature.

FIG. 22 represents the devices of convection heaters with the use of tubular electric heaters in the following alternatives: a—Convection heater pursuant to claim 30, consisting of the frame in which the convection tubular electric heater 50 is installed, constructed pursuant to claim 24, electric fan 67 ensuring the air flow, upper deflector 65, lower deflector 68 and the control system 85 with electronic temperature regulator 70. The heating device and the following temperature sensors are connected to the control system 85: sensor 72 of the temperature on the radiator board that switches off the electric energy supply when the temperature on the surface increases above the level of 75 C° to 95 C°, sensor 73 of the temperature on the outside surface of the radiator for measuring the ambient temperature and sensor 74 of the temperature within the zone of the installation of the heating device mounting in the vicinity of the tubular unit element 55. The required temperature values are determined with the use of the electronic temperature regulator 70. The electric fan 67 that regulates the speed of air flow on the surface of the convection heater is connected to the control system 85. The device further contains the front panel 61 of the radiator, convection tubular electric heater 50 constructed pursuant to claim 24, radiator lamellae 56 with developed surface, vertical thermally conductive panel 64, assembly fixtures brackets 66 for the installation of the convection tubular electric heater 50 and the back panel 69 of the radiator.

b—Convection heater pursuant to claim 31 consists of the frame, inside which a tubular 4-lamella heater 53 is installed, constructed pursuant to claim 25. The device further contains the upper deflector 65, front panel 61 of the radiator, radiator lamellae 56 with developed surface, assembly fixtures brackets 66 for the installation of the tubular 4-lamella heater 53 and the back panel 69 of the radiator.

FIG. 23 illustrates the control system 85 used for the implementation of the different methods and for the operation of the devices pursuant to claims 1 through 31. Control system based on a microcomputer 101, as the main control device with specialised software, implemented for functioning in accordance with the methods and devices pursuant to claims 1 through 31, in combination with the liquid heating systems of accumulation or flow-through type or convection heaters with various alternatives of heating devices utilising energy from the hydrocarbon fuel sources or from electric sources. The example illustrates the connection 105 of the heating device with four groups of initiation heaters and four groups of emission heaters and a common conductor. The control system contains the end groups 107 of contacts for the connection of heating devices, specifically between 2 and 8 contacts from the sections of the initiation heater and the emission heater with the use of the communication interface 106 for the connection of the heating device to the input of the control system to the measuring unit 104 with eight resistors, connected to 8-channel PWM (Pulse Width Modulation) modulator 110 that is connected to the supply source 125 of the control system and to the microcomputer 101. The aforementioned 8 segments of the heating device also have a common contact and are connected to the terminal C and to the supply source 125 of the control system and the microcomputer. The electric voltages measured at the resistances are guided, through the measuring unit 104 with eight resistors, to the input of the 8-channel analogue multiplexer 108 connected to the microcomputer 101, from the output of which the measured values are subsequently transmitted to the input of the ADC converter 109, the output of which is also connected to the input of the microcomputer 101. The end groups 115 of contacts for the connection of temperature sensors are designed for the connection of up to four temperature sensors 114 determining the temperature of the heating devices, liquid and air. The sensors are connected to the 4-channel ADC converter 116, from which the data is also transmitted to the input of the microcomputer 101. The sensor 111 of the liquid flow meter is connected to the input of the signal digitisation block 113 from the flow meter sensor through the contacts 112 for the connection of the flow meter sensor and also to the input of the microcomputer 101. The end group 119 of contacts for the connection of the hydrocarbon fuel burners is connected, by means of the 4-channel DAC converter 118, to the control unit 117 of hydrocarbon fuel burners, to which the end group 120 of contacts for the connection of the closure valves of hydrocarbon fuel burners is also connected. The control unit 117 of the hydrocarbon fuel burners is connected to the output of the microcomputer 101. Four groups of relay contacts 124 for controlling the external devices, such as pumps, fans and/or other analog devices needed for the operation of the heating system are connected to the end group 123 of contacts for the connection of external devices with relay contacts. Other devices connected to the microcomputer 101 include electronic temperature regulator 70 of the heating temperature of the heated liquid or air that determines the required temperature values of the heating of the controlled devices, heating of the liquid or volume of the ambient air, supply source 125 of the control system and the microcomputer and other devices of the control system 85. The control system 85 is equipped with standard computer communication interfaces 126 for the connection of external devices for programming, monitoring and recording information.

### OVERVIEW OF THE ITEMS IN THE SCHEME

### 1—Heater.

The main element, structured as a porous ceramic electrically conductive tubular element, made of a high-temperature withstanding ceramic containing a mixture of powders SiC, ZrO₂, Al₂O₃ and carbon (C) powder, and a fuel mixture of hydrogen-containing chemical compounds of aluminium (Al) and lithium (Li), such as lithium aluminium hydride (LiAlH₄). As well the alternative, the porous ceramic electrically conductive tubular element, made of a high-temperature withstanding ceramic contains a catalyst metal powder, such as nickel (Ni), and a fuel mixture containing the chemical elements hydrogen (H) and lithium (Li) is proportionally distributed inside the pores.

2—Metallic contacts of the upper part of the heater.

Metallic contacts of the upper part of the heater, made of a conductive high-temperature withstanding metal, such as an alloy of nickel (Ni) and chrome (Cr), Ni35Cr20, with adhesion to the ceramic base, allowing for laser welding of the terminals made of nickel (Ni) alloys at the temperature Tmax=900-1250° C.

3—Metallic contacts of the lower part of the heater.

Metallic contacts of the lower part of the heater, made of a conductive high-temperature withstanding metal, such as an alloy of nickel (Ni) and chrome (Cr), Ni35Cr20, with adhesion to the ceramic base, allowing for laser welding of the terminals made of nickel (Ni) alloys at the temperature Tmax=900-1250° C.

4—Terminal of the upper contact with a metal conductor.

Terminal of the upper contact with a metal conductor, made as an insulated metallic conductor of a high-temperature withstanding metal allowing welding conductors with the insulation and shell of quartz fibres (Tmax=1000 ° C.).

5—Terminal of the lower contact with a metal conductor.

Terminal of the lower contact with a metal conductor, made as an insulated metallic conductor of a high-temperature withstanding metal allowing welding conductors with the insulation and shell of quartz fibres (Tmax=1000 ° C.).

6—Ceramic insulation insert.

Ceramic insulation inserts for the sealing and electric insulation of conductors of the upper and lower terminals and for thermal insulation of the case of the heating device from the inner surface, made in accordance with the technology of high-temperature forsterite ceramic the crystalline base of which is based on magnesium orthosilicate Mg₂SiO₄. Fosterite ceramic differs in its high coefficient of linear temperature expandability at the level of (109±5) 10⁻⁷K⁻¹, within the temperature range of 1250° C. (in the vicinity of the same parameter as applicable to nickel (Ni)).

7—Inner surface of the heating device.

Inner surface of the heating device equipped with screw, made of a nickel alloy.

8—Electric insulation.

Electrical insulation of the heater made of applying of insulating layer of AI₂O₃.

9—Channel in the heater.

Channel in the heater for the common contact to the terminal, equipped with electric insulation of the inner surface of porous, to prevent the short circuit.

10—Case of the heating device.

Case of the heating device made of a nickel alloy (Ni).

11—Flange of the heating device base.

Flange of the heating device base contains hermetically welded contact with the case at the lower part of the heating device, made by laser welding.

12—Openings in the flange used for the fixation of the heating device.
13—Flange at the lower part of the heating device with external screw thread.
14—Case covered with porous ceramic material.

Case of the heating device made of a nickel alloy (Ni), covered with porous ceramic material.

15—Screw thread connection.

Screw thread connection for connecting the heating device.

17—Inner surface of the composed heater.

Inner surface of the composed heater, equipped with crew threads, made of a nickel alloy (Ni).

21—Burner for hydrocarbon fuel.

Burner for hydrocarbon fuel, for example fuel gas; standard construction.

22—Liquid temperature sensor at the input t₁° C.

Liquid temperature sensor used for measuring the temperature at the input, standard construction.

23—Liquid temperature sensor at the heat exchanger t₂° C./Temperature sensor at the coat of the heating device t₂° C. Temperature sensor used for measuring the temperature, placed either at the heat exchanger or at the coat of the heating device, depending on the heating system used; standard construction.
24—Liquid temperature sensor at the output t₃° C.

Liquid temperature sensor used for measuring the temperature at the output, standard construction.

27—Inner surface of the composed heating device.

Inner surface of the composed heating device, equipped with crew threads, made of a nickel alloy (Ni).

41—Initiation heater.

Initiation heater, the heater placed at the composed heater, receiving external thermal energy and subsequently heating the emission heater, placed in an immediate contact with its inner or outer surface.

42—Emission heater.

Emission heater, the heater placed at the composed heater, thermal energy is removed from inner or outer emission surface.

43—Channel of guiding the common contact to the terminal.

Channel of guiding the common contact to the terminal, placed at the composed heater for terminal of the common contact, equipped with electric insulation of the inner surface of porous to prevent the short circuit.

44—Terminal of the common contact.

Terminal of the common contact, made as an insulated metallic conductor of a high-temperature withstanding metal allowing welding conductors with the insulation and shell of quartz fibres (Tmax=1000 ° C.).

45—Terminal of the initiation heater/Terminal from individual sections of the initiation heater.

Terminal of the initiation heater, made as an insulated metallic conductor of a high-temperature withstanding metal allowing welding conductors with the insulation and shell of quartz fibres (Tmax=1000 ° C.).

46—Terminal of the emission heater/Terminal from individual sections of the emission heater.

Terminal of the emission heater, made as an insulated metallic conductor of a high-temperature withstanding metal allowing welding conductors with the insulation and shell of quartz fibres (Tmax=1000 ° C.).

50—Convection tubular electric heater.

Convection tubular electric heater, made as a two-lamella tubular heater, equipped with lamella segments to improve convective heat transmission.

51—Mounting point of the heating device in the tubular heater.

Mounting point of the heating device in the tubular heater, equipped with crew threads and the sealing.

52—Assembly position of the heating device in the tubular heater.
53—4-lamella tubular heater.

4-lamella tubular heater, equipped with lamella segments to improve convective heat transmission.

55—Tubular unit.
56—Radiator lamellae with developed surface

Radiator lamellae with developed surface for improving the convection heat transmission.

61—Front panel of the radiator.

Front panel of convection radiator, standard construction.

64—Vertical thermally conductive panel.

Vertical thermally conductive panel of the tubular heater made of an aluminium alloy, standard construction.

65—Upper deflector.

Upper deflectors for creating a direct warm air flow.

66—Assembly fixtures.

Assembly fixtures for fixing a tubular electric heater made of aluminium alloy, standard construction.

### 67—Electric fan.

Electric fun for ensuring the air flow.

68—Lower deflector.

Lower deflectors for cold air supply.

69—Back panel of the radiator.

Back panel of the radiator made of an aluminium alloy, standard construction.

70—Electronic temperature regulator.

Electronic temperature controller determines the required values of temperature for heating controlled devices, liquid or volume of surrounding air, it operates under the thermostat.

72—Temperature sensor at the radiator board.

Temperature sensor, placed at radiator board, standard construction.

73—Temperature sensor at the outside surface of the radiator.

Temperature sensor, placed at the outside surface of the convection radiator, standard construction.

74—Temperature sensor within the zone of the heating device mounting.

Temperature sensor, placed within the zone of the heating device, standard construction.

80—Heating device.

Heating device, used in the system of liquid heating, depending upon variant of implementation, for flow-through and accumulation systems, typical (simple), composed, ore more section, is directly connected to the control system and power source, such as burner for generating heat energy, removed from its outer or inner surface.

81—Socket for the liquid supply.

Socket for supplying liquid to the input of the liquid heating system, standard construction.

82—Liquid supply pump.

Liquid supply pump to create a forced circulation of the liquid in the heating system, standard construction.

83—Liquid flow meter.

Flow meter for measuring the liquid flow, standard construction.

84—Socket for liquid removal.

Socket for liquid removal placed at the output of the liquid heating system, standard construction.

85—Control system.

A typified control system constructed in accordance with the technology of integrated circuits made of radio-electronic components for general use, designed for controlling the heating devices depending on the particular alternatives and devices included in the system, based on algorithms in line with the given software. The control system of the convection heater constructed in accordance with the technology of integrated circuits made of radio-electronic components for general use, designed for controlling the heating devices depending on the particular alternatives and devices included in the system, based on algorithms in line with the given software.

86—Closure valve.

Closer valve of the burner for hydrocarbon fuel, standard construction.

87—Thermally insulated accumulation tank.

Thermally insulated accumulation tank, standard construction.

88—Heat exchanger.

Radiator for heat transfer, improving the process of heat transfer from the surface of heating devices, according to the variant of implementation, standard construction.

### 89—Construction.

Construction (sheath) of the heating system equipped with thermal insulation, standard construction.

90—Control unit of fuel supply to the burners.

Control unit of fuel supply to the burners, standard construction.

91—Combustion products trap.

Combustion products trap, standard construction.

92—Thermal insulation.

Thermal insulation of the heating device made of porous ceramic or glass fibres, standard construction.

### 101—Microcomputer.

Microcomputer, as the main control device with specialised software.

103—Contacts for the connection of external electric supply.

Contacts for the connection of external electric supply, a group of contacts for supply voltage of 230V.

104—Measuring unit with eight resistors.

Measuring unit contains the end groups of contacts and 8 resistors R₁-R₈ measuring the voltage in the heater, or in the sections of the initiation or emission heaters, from which the voltage for the next measuring of resistance in the zone of LENR reaction is obtained.

105—The connection of the heating device with four groups of initiation heaters and four groups of emission heaters and a common conductor.

The connection of the heating device of composed type containing initiation and emission heaters, variants of more section heat devices containing one, two, three or four segments, in accordance with the variant of implementation, with common contact C.

106—Communication interface of the connection of the heating device to the input of the control system.

Communication interface of the connection of the heating device to the input of the control system, using the high-temperature withstanding conductors made of nickel and chrome alloy, with insulation and shell of quartz fibres (Tmax=1000 ° C.).

107—End group of contacts for the connection of heating devices.

End group of contacts for the connection from 1 to 8 of contacts from sections of the initiation heater and the emission heater and common contact C of the heaters.

108—Analogue multiplexer.

8-channel analogue multiplexer for supplying the voltage measured at the measuring resistors R₁-R₂ from the heaters of the variants of heating devices for measuring the resistance of the heaters during LENR reaction.

109—ADC converter.

ADC converter (Analog-Digital Converter) for converting of the analog signal values of measured resistance of the heaters to digital.

110—PWM modulator.

Eight-channel PWM (Pulse Width Modulation) modulator of the electric power to supply an initiation thermal energy to the heating device passing of electric current through heating element and for the heating of sections of the heating device—initiation heater and emission heater, and also to supply power for measuring resistance of the heaters at 10% of nominal power initiation. Pulse width modulation (PWM) is the modulation for the transmission of varying analogue signal power by supplying of pulse voltages to the heater. PWM modulator is used to reach a signal, which continuously switches between the maximum and the minimum values of the supply voltage. This signal modulates the voltage between the maximum value (48 V) and the minimum value (0 V) by changing the length of the switch on time 48 V relative to switch on 0 V. The duration of switch on of the maximum value is called pulse width. To obtain different analogue values of supplied power to the heater, the pulse width is changed. At a sufficiently rapid period of change of on/off is possible to supply a constant signal between 0 V and 48 V to the heating device and control the current and power of the thermal initiation or minimal necessary power in the range of 10% of the nominal value for the determination of the resistance of the heater in the control modes of process of LENR reaction.

111—Liquid flow meter sensor.

Liquid flow meter sensor, standard construction.

112—Contacts for the connection of the flow meter sensor.

Contacts for the connection of the liquid flow meter sensor.

113—Block for digitisation of signals from the flow meter sensor.

Block for digitisation of signals from the liquid flow meter sensor.

114—Temperature sensors.

Temperature resistance sensors, standard construction.

115—End group of contacts for the connection of temperature sensors.

End group of contacts for the connection up to 4 temperature sensors for measuring of the temperature of heating devices, liquid and air.

116—ADC converter, 4-channel.

ADC converter (Analog-Digital Converter) 4-channel converter signals from the temperature sensors, for converting the resistance analog signal to the digital.

117—Control unit of the hydrocarbon fuel burners.
118—DAC converter, 4-channel.

DAC (Digital-Analog Converter) 4-channel converter controlling the power of hydrocarbon fuel burners.

119—End group of contacts for the connection of hydrocarbon fuel burners.
120—End group of contacts for the connection of closure valves of the hydrocarbon fuel burners.

End group of contacts for the connection up to 4 closure valves of the hydrocarbon fuel burners.

121—Hydrocarbon fuel burners with closure valves.
122—Control unit of external devices.

Control unit of external devices, needed for the operating of the heating system.

123—End group of contacts for the connection of external devices with relay contacts.

End group of contacts for four groups of relay contacts for the connection of external devices such as pumps, fans and/or other analog equipment needed for the operation of the heating system.

124—Control contacts of external devices.

Control contacts of external devices, needed for the operation of the heating system.

125—Supply source

Supply source of the control system and microcomputer.

126—Communication computer interface for the connection of external devices.

Standard communication computer interface for the connection of external devices for programming, monitoring and recording of information.

### Examples of Construction

Description of the functioning of the heater, heating devices and their different alternatives pursuant to this invention, in combination with the control system.

The functioning of the heater and the heating devices in accordance with the specified methods of thermal energy production, consisting of the use of chemical elements participating in the exothermic LENR reaction with mutual impacts of the reaction material composed of the catalyst in the form of a powder of the metals of the 10th group of the Periodic Table, such as nickel (Ni), and a fuel mixture of hydrogen-containing chemical compounds of aluminium (Al) and lithium (Li), such as lithium aluminium hydride (LiAlH₄) under the conditions of initiation by means of external thermal impacts.

The main element of the heating devices, in accordance with the claims covered by the invention, is the heater 1, the pores of which are filled with the reaction material containing a catalyst in the form of nickel (Ni) powder and a fuel mixture, such as lithium aluminium hydride (LiAlH₄). The heater 1 contains metallic contacts 2 placed in the upper part of the heater and metallic contacts 3 placed in the lower part of the heater, ceramic insulation inserts 6 placed at the ends of the heater 1 for the fixing, thermal insulation and electric insulation of the heater 1 from the case 10 of the heating device. The heating device contains the inner surface 7 of the heating device and outer case 10 of the heating device, electric insulation 8 of the outer and inner surface of the heater 1 from the case 10 of the heating device and a channel 9 in the heater used for guiding out the metallic contacts (2) of the upper part of the heater.

In terms of construction, the heater 1 is structured as a tubular unit, with terminals 4 of the upper contact with a metal conductor and 5 of the lower contact with a metal conductor being placed on the opposite ends, connected to the input of the control system 85.

Upon activation of the heater 1 and the start of operation as a Thermal Energy Reactor (TER), the inside volume of the heater 1 is being heated and the thermal energy is being removed from the case 10 of the heating device or from the inner surface 7 of the heating device, depending on the particular alternative of construction. The activation occurs upon supplying of the initiation electric or thermal energy to the heater 1.

The electric activation occurs upon voltage supply from the PWM modulator 110, controlled by the microcomputer 101 through the measuring unit 104 with eight resistors and the end group of contacts 107 for the connection of heating devices through the communication interface 106 of the connection of the heating device to the input of the control system. The measuring of the active component of the current value passing through the heater 1 between the terminal 4 of the upper contact with a metal conductor and the terminal 5 of the lower contact with a metal conductor takes place in the form of measuring the voltage at the resistor R₁ of the measuring unit 104 with eight resistors; the electric voltage obtained at this resistor is transmitted to the input of the analogue multiplexer 108 controlled by the microcomputer 101, from the output of which the measured values of voltage are subsequently transmitted to the input of the ADC converter 109, the output of which is also connected to the input of the microcomputer 101. This connection of the specified devices enables to control, in line with the given software, the process of the initiation thermal energy supply to the heater 1 and to control the processes taking place within the zone of the LENR reaction for the given algorithm.

In the course of the initiation of the heater 1 in line with the initiation software, the control system 85 supplies voltage according to the program of accelerated heating with PWM modulation of the current impulse parameters, with the monitoring of the parameters of the current passing through the porous ceramic electrically conductive heater 1.

In the course of the thermal initiation of the porous ceramic electrically conductive heater 1, in which the reaction material is distributed, at the determined temperatures ranging between 450° C. and 900° C., the process of low temperature nuclear fusion is initiated in the reaction zone, associated with the release of thermal energy and its removal from the case 10 of the heating device or from the inner surface 7 of the heating device, as the case may be.

During this process, the control system 85 ensures the control and maintenance of the parameters of the heating device operation based on the main characteristic, i.e. the electric resistance measured during the operation process—measuring and calculation of the speed or acceleration (the first derivation d′i/dt, or acceleration, the second derivation d″i/dt²) based on the value of the electric current passing through the heater 1, which is the function of the inside temperature of the ceramic heater at which the LENR reaction occurs.

A sharp decrease of the resistance in the heater 1 occurs at the moment when the Debye temperature in the fuel mixture is exceeded and melting zones of the catalyst crystalline powder are created, where the catalyst metal loses its crystalline structure, which eventually results in the interruption of the LENR reaction. The values of the first and second derivations may be analysed in each cycle of the current supply to the heater 1 and in the case of their increase by 10% to 20% compared to the values of the preceding measuring cycle, the output supplied by the PWM modulator 110 to the terminal 4 of the upper contact with a metal conductor and terminal 5 of the lower contact with a metal conductor is automatically reduced.

The control system 85 is used for the calculation of the current value for the current state of the heater 1 and the compliance is defined of its value with the value of the approximated current temperature. If the current value in a single step exceeds the permitted value or if it is increasing in the speed or with the acceleration exceeding the standard of 20% of the preceding measuring, then the temperature obviously reaches the level when the catalyst metal can melt and the resistance of the porous ceramic electrically conductive heater 1 with the reaction material is decreased in the proportion corresponding to the measured current value. The control system 85 responds by means of reducing the level of heat impact on the heater 1, maintaining its operation mode within the pre-determined temperature range, calculated for the given type of the heater 1 and its operation modes. The parameters of the values of the current and resistance of the heater 1, as the basic conditions launching the switch-off mode, are recorded in the memory of the microcomputer 101 and the control system 85 uses them for the calculation of the start of the switch-off mode in the subsequent cycles under the conditions in which the controlled LENR process takes place by means of disconnecting the supply or by means of thermal energy supply to the heater and the reaction material within the range of minus (5 to 10)% of the initial temperature of the catalyst melting.

The voltage impulses from the PWM modulator 110 continue to flow to the heater 1 with a reduced output at the level of 10% of the nominal value of the preceding measuring cycle for the purpose of the resistance increase control and if the measured value of resistance increased by 10% of its value at the moment of the thermal impact disconnection, the process of thermal energy supply with the supply of electric current from the PWM modulator 110 to the heater from the control system 85 is repeated.

This means that the PWM modulator 110 generates two ranges of output, i.e. the output at the initiation output level, considered to be the nominal value, and the output at the level of the specific current equal to 10% of the nominal value of output, depending on the software of the control system 85.

In the operation of the heating device comprising a flow-through and accumulation system for the liquid heating or a convection heater, used for reducing the thermal energy supply to the heating device and proportionally to the heater 1, external devices of liquid recirculation are additionally connected, the speed of the liquid supply pump 82 is increased or the convection heater is being fanned, which results in the reduction of the temperature of the case 10 of the heating device and the temperature decrease within the zone where the LENR reaction takes place.

Since the thermostatic function during the operation of the control system 85 is ensured through the control of the electric resistance at the heater 1, the temperature for the adaptive process of control at which the LENR reaction takes place is actually maintained by means of disconnecting or connecting the thermal energy supply to the heater 1 and to the reaction material within the range of minus (5 to 10)% of the initial temperature of the catalyst melting, for which purpose the supply/removal units of thermal energy are connected to the output of the control system 85 in accordance to the algorithm specified above.

External heat activation occurs upon the supply of the initiation thermal energy to the heater 1, with the use of hydrocarbon fuel, for example by means of the burner 21 for hydrocarbon fuel. Depending on the particular alternative of the heating device used, thermal energy can be supplied to the inner surface 7 of the heating device or to the outer case 10 of the heating device.

In such a case, the operation of the heating device is analogous to the process described above, with a number of differences associated with the use of the burners 21 for hydrocarbon fuel and with the long time of the heat impact of the thermal energy relaxation in the event of repeated initiation of the heater 1, which is reflected in the need of precise measurement of the value of resistance at the heater 1 and the fluctuations of the values of the measured current, both ensured by the control system 85. During this process, the control and maintenance of the parameters of the heating device operation is ensured based on the main characteristic, i.e. the electric resistance measured during the operation process—measuring and calculation of the speed or acceleration (the first derivation d′i/dt, or acceleration, the second derivation d″i/dt²) based on the value of the electric current passing through the heater 1, which is the function of the inside temperature of the ceramic heater at which the LENR reaction occurs. And because the initiation thermal energy is supplied from the outside, the control function is ensured by means of the current passing through the heater 1 only for the analysis of the resistance changes in critical conditions.

The specific current impulses from the PWM modulator 110 continue to flow to the heater 1 with a reduced output at the level of 10% of the nominal value of the preceding measuring cycle for the purpose of controlling the resistance within the zone where the LENR reaction takes place. When the measured value of resistance is lower by 10% compared to the value measured in the preceding measuring, the thermal impact is disconnected by means of switching off the fuel supply to the burner 21 for hydrocarbon fuel from the end group 120 of contacts for the connection of the closure valves of the hydrocarbon fuel burners (up to four closure valves) or the output is being controlled in an analogous manner from the end group 119 of contacts for the connection of hydrocarbon fuel burners. Furthermore, in the course of the electric current passing from the PWM modulator 110 to the heater 1 with a reduced output at the level of 10% of the nominal value, the control of resistance increase at the heater 1 is ensured and if the measured value of resistance increases by 10% of its value measured at the moment of the thermal impact disconnection (switch-off), the process of thermal energy supply to the heater 1 from the control system 85 is repeated by means of connecting the burner 21 for hydrocarbon fuel from the end group 119 of contacts for the connection of hydrocarbon fuel burners or from the end group 120 of contacts for the connection of closure valves of the hydrocarbon fuel burners, depending on the given type of the gas device.

The burners 21 for hydrocarbon fuel and the closure valves 86 are controlled in accordance with the standards determined for the given technical area for the liquid heating systems of accumulation or flow-through type with a relay control system from the end group 120 of contacts for the connection of closure valves of the hydrocarbon fuel burners and with an analog control system from the end group of contacts for 4 channels of independent control, by means of signals coming from the microcomputer 101 to the input of the control unit 117 of the hydrocarbon fuel burners and to the 4-channel DAC converter 118 and then to the aforementioned burners 21 for hydrocarbon fuel from the end group 119 of contacts for the connection of hydrocarbon fuel burners. The operation of the heating devices with the supply of external thermal energy to the heater 1 from the burner 21 for hydrocarbon fuel in various construction alternatives with the heating of the inner surface 7 of the heating device or of the outer case 10 of the heating device does not significantly differ for the control system 85.

Nonetheless, in order to accelerate the activation of the heating devices described above, it is possible to obtain the initial thermal initiation by means of supplying electric energy to the heater 1 at the moment of switching, simultaneously with the activity of the burner 21 for hydrocarbon fuel. After the initial thermal initiation in the form of the initiation output supply from the PWM modulator 110 through the heater 1 and the start of the LENR reaction mode, the level of the output supply to the heater 1 is determined only as the measured current with 10% of the nominal value of the initiation output, and the external initiation thermal energy is subsequently supplied only from the burner 21 for hydrocarbon fuel.
Differences in the control of heating devices containing composed heaters with both initiation heaters 41 and emission heaters 42.

In principle, the technology of control and information processing by the control system 85 in the mode of thermostatic control of LENR processes in a composed heating device, constructed for example by means of the connection 105 of the heating device with four groups of initiation heaters and four groups of emission heaters and a common conductor, does not differ from the mode described above with respect to the typified (simple) heating device.

The electric activation occurs upon voltage supply from the PWM modulator 110, controlled by the microcomputer 101 through the measuring unit 104 with eight resistors used for measuring of the voltage at the heater or the heater section and the end group of contacts 107 for the connection of heating devices through the communication interface 106 of the connection of the heating device to the input of the control system.

The measuring of the active component of the current value passing through the heating device between the contacts: common terminal 44 or the C contact and the terminal 45 of the initiation heater and terminal 46 of the emission heater takes place in the form of measuring the voltage at the resistors R₁-R₈ of the measuring unit 104 with eight resistors; the electric voltage measured at these resistors is transmitted to the input of the analogue multiplexer 108 controlled by the microcomputer 101, from the output of which the measured values of voltage are subsequently transmitted to the input of the ADC converter 109, the output of which is also connected to the input of the microcomputer 101. This connection of the specified devices enables to control, in line with the given software, the process of the initiation thermal energy supply to the initiation heater 41 and to control the processes taking place within the zone of the LENR reaction for the given algorithm. Different alternatives of using the heating devices of section type can contain one, two, three or four sections, depending on the used alternative of the heating device construction. Depending on the given alternative, resistors R₁ R₂ R₃ R₄ R₅ R₆ R₇ R₈ are used in the measuring unit 104 with eight resistors, on which the resistance of the initiation heater 41 is being controlled by means of measuring in the course of the LENR reaction, as well as the resistance of the emission heater 42 and a separate measuring of their sections, and the determination of the initial moment of the catalyst melting point. The temperature for the adaptive process of control at which the LENR reaction takes place is actually maintained separately at each section of the heater, by means of disconnecting or connecting the thermal energy supply to the initiation heater 41 and to the reaction material within the range of minus (5 to 10)% of the initial temperature of the catalyst melting, for which purpose the supply/removal units of thermal energy are connected to the output of the control system 85 in accordance to the algorithm specified above.

The processes of measuring the current values in the heater and its fluctuations in the pre-defined controlled parameters are performed by the control system 85 in accordance with the software of the microcomputer 101 that controls the PWM modulator 110 for all alternatives of the heating devices, implemented for example by means of the connection 105 of the heating device with four groups of the initiation heaters and four groups of the emission heaters and a common conductor, and it also controls the operation of the analogue multiplexer 108 and the ADC converter 109 that converts voltage at the measuring resistors R₁-R₈ of the measuring unit 104 with eight resistors, with the use of which the level of the current in the heaters and sections of the heaters is composed, as well as their resistance, which eventually represents a function of the LENR process control. The devices specified above are in accordance with the software adapted for the operation with the heating devices based on the particular alternatives of their construction and use.

During this process, the control system 85 ensures the control and maintenance of the parameters of the heating device operation based on the main characteristic, i.e. the electric resistance measured during the operation process—measuring and calculation of the speed or acceleration (the first derivation d′i/dt, or acceleration, the second derivation d″i/dt²) based on the value of the electric current passing through the initiation heater 41 and the emission heater 42 or their sections, which is the function of the inside temperature of the ceramic heater at which the LENR reaction occurs.

In such a case, the operation of the heating device is analogous to the process described above, with a number of differences associated with the use of several sectional heating devices comprising couples of sections of the initiation heater 41 and the emission heater 42, which is reflected in the need of precise measurement of the value of resistance at the heaters in the course of cyclical step by step connecting of individual sections of the heater to the output supply and the measuring of the resistance values of the heaters within the zone of the LENR reaction during the measuring of the values of the flowing current, ensured by the control system 85. During this process, the control and maintenance of the parameters of the heating device operation is ensured based on the main characteristic, i.e. the electric resistance of individual sections of the heaters measured during the operation process—measuring and calculation of the speed or acceleration (the first derivation d′i/dt, or acceleration, the second derivation d″i/dt²) based on the value of the electric current passing through the sections of the heaters, which is the function of the inside temperature of the ceramic heater at which the LENR reaction occurs. And because the initiation thermal energy is supplied in a cyclical manner, the control function is ensured through the cyclical passage of current through the heater in the mode of the output supply and measuring of the resistance of the heaters within the zone where the LENR reaction takes place, for the purpose of analysing the resistance change in cyclical modes with the measuring repetition frequency of 100 times per second.

The existence of two, three or four composed sections of initiation heaters 41 and emission heaters 42 in the heating device also differs in a number of aspects from the examples provided above, because the control system 85 contains hardware and software adapted for a multi-channel resistance measuring of these composed heaters and for the control of the heating modes in the course of the LENR reaction in such heating devices.

For example, in the case of a composed heating device with initiation heaters 41 and emission heaters 42 a cyclical mode occurs of the output supply and measuring of the resistance of the heaters within the zone where the LENR reaction takes place, for the purpose of analysing the resistance change in cyclical modes with the measuring repetition frequency of 100 times per second, in couples of measuring resistors R₁ R₂.

In the alternative of the heating device with two sections, such analysis of the resistance change measurements takes place on couples of measuring resistors (R₁ R₃); (R₂ R₄).

In the alternative of the heating device with three sections, such measurement of the resistance change takes place on couples of measuring resistors (R₁-R₄); (R₂-R₅); (R₃-R₆).

In a composed four-sectional heating device, the control of eight heaters is performed and the control system 85 controls the sections of the heating device with coupled initiation heaters 41 and emission heaters 42—(R₁-R₅); (R₂-R₆); (R₃-R₇); (R₄-R₈) in cycles of step-by-step supply of output and control of the resistance level within the zone where the LENR reaction takes place in each of the sections of the composed heater. This is performed by means of structuring the synchronised cycles of the output supply of the initiation heating or measuring at the determined channel from 1 to 8, with the output supply from the PWM modulator 110, supplying current in steps from its output to the resistors R₁, R₅, R₂, R₆, R₃, R₇, R₄, R₈ of the measuring unit 104 with eight resistors, based on the software adapted for the given type of the heating devices.

In the course of this process, similarly as in the examples provided above, the specific current impulses from the PWM modulator 110 continue to flow to the heater with a reduced output at the level of 10% of the nominal value of the output for the purpose of controlling the resistance within the zone where the LENR reaction takes place. When the measured value of resistance is lower by 10% compared to the value measured in the preceding measuring, the thermal impact is disconnected by means of switching off the output supply from the PWM modulator 110. Furthermore, in the course of the electric current passing from the PWM modulator 110 to the heater with a reduced output at the level of 10% of the nominal value at the relevant section of the initiation heater 41, the control of resistance increase at the heater is ensured and if the measured value of resistance increases by 10% of its value measured at the moment of the thermal impact disconnection (switch-off), the process of the output supply to the section of the initiation heater 41 is repeated as described above.

In order to accelerate the activation of the heating devices described above, it is possible to obtain the initial thermal initiation by means of supplying electric energy to the initiation heater 41 and to the emission heater 42 at the moment of switching. After the initial thermal initiation in the form of the initiation output supply from the PWM modulator 110 simultaneously to the initiation heater 41 and the emission heater 42 and after the start of the LENR reaction mode, the level of the output supply to the heaters is determined only as the specified current at the value of 10% of the nominal value of the initiation output, and the electric output is subsequently supplied through the control system 85 only to the in initiation heater 41, while the emission heater 42 only receives output at the level of the specified current at the value of 10% of the nominal value of the initiation output.

External heat activation occurs upon the supply of thermal energy to the heating device with the use of hydrocarbon fuel, for example by means of the burner. Depending on the particular alternative of the heating device used, thermal energy can be supplied to the inner surface or to the outer surface of the heating device.

The burners and the closure valves are controlled in accordance with the standards determined for the given technical area for the liquid heating systems of accumulation or flow-through type with a relay control system from the end group 120 of contacts for the connection for closure valves of the hydrocarbon fuel burners and with an analogue control system from the end group of contacts for 4 channels of independent control, based on signals coming from the microcomputer 101 to the input of the control unit 117 of the hydrocarbon fuel burners and to the 4-channel DAC converter 118 and then to the burners 21 for hydrocarbon fuel from the end group 119 of contacts for the connection of hydrocarbon fuel burners.

The operation of composed heating devices with the supply of external thermal energy to the devices from the burner of hydrocarbon fuel in various construction alternatives with the heating of the inner surface 27 of the composed heating device or of the outer case 10 of the heating device does not significantly differ for the control system 85 from the examples listed above.

In such a case, the operation of the heating device is analogous to the process described above, with a number of differences associated with the use of the burners 21 for hydrocarbon fuel and with the long time of the heat impact of the thermal energy relaxation in the event of repeated initiation of the heater and with the use of several sectional heating devices comprising coupled sections of the initiation heater 41 and the emission heater 42, which is reflected in the need of precise measurement of the value of resistance at the heater and the fluctuations of the values of the specified current of the combined initiation heater 41 and the emission heater 42, both ensured by the control system 85. The algorithms of the activity of the control system 85 and of the different alternatives of construction of the composed heating devices correspond with the algorithms specified above.
Example of the control system functioning

The control system 85 illustrated in FIG. 23 consists of standard electronic components and is constructed in line with the requirements pertaining to electronic circuits, based on a microcomputer 101, as the main control device with specialised software supporting operation of the system according to the given algorithms. This enables its operation in the structure of flow-through, or accumulation systems for liquid heating, or convector heaters. The heating devices, implemented according to the patent, equipped with the initial heaters 41 and the emission heaters 42 are connected in accordance with the connection scheme 105 of the heating device with four groups of initiation heaters and four groups of emission heaters and with a common conductor, with external thermal initiation of the heating process by means of hydrocarbon fuel or electric current. The end group of contacts 107 for the connection of heating devices contains the contacts for connection between 1 and 8 contacts from the heating device or from various alternatives of the composed heating devices containing sections of initial heaters 41 and emission heaters 42 with the use of the communication interface 106 of the connection of the heating device to the input of the control system to the measuring unit 104 with eight resistors, for measuring the voltage of the sections of the heat devices, connected to 8-channel PWM modulator 110 that is connected to the supply source 125 of the control system and to the microcomputer 101. The aforementioned 8 segments of the heating device (four groups of initiation heaters and four groups of emission heaters) have a common conductor C. The electric voltages measured at the resistances are guided to the input of the 8-channel analogue multiplexer 108 connected to the microcomputer 101, from the output of which the measured values are subsequently transmitted to the input of the ADC converter 109, the output of which is also connected to the input of the microcomputer 101. The end group 115 of contacts for the connection of temperature sensors, up to 4 temperature sensors 114 determining the temperature of the heating devices, liquid and air. The sensors are connected to the 4-channel ADC converter 116, from which the data is also transmitted to the input of the microcomputer 101. The sensor 111 of the liquid flow meter is connected to the input of the signal digitisation block 113 and also to the input of the microcomputer 101. The end group 119 of contacts for the connection of the hydrocarbon fuel burners is connected, by means of the 4-channel DAC converter 118, to the control unit 117 of hydrocarbon fuel burners, to which the end group 120 of contacts for the connection of the closure valves of hydrocarbon fuel burners is also connected. The control unit 117 of the hydrocarbon fuel burners is connected to the output of the microcomputer 101. The end group 123 of contacts for the connection of external devices with relay contacts, controlling pumps, fans and/or other analog devices needed for the operation of the heating system, other devices of control system 85 connected to the microcomputer 101 include electronic temperature regulator 70 of the heating temperature of the heated liquid or air that determines the required temperature values of the heating of the controlled devices, heating of the liquid or volume of the ambient air. Supply source 125 of the control system and of the microcomputer connected to the group of contacts 103 for the connection of external electric supply and of other devices of control system. The control system 85 is equipped with standard computer communication interfaces 126 for the connection of external devices for programming, monitoring and recording information.

As an example, the operation of the control system 85 is described, with a composed heating device in accordance with the connection scheme 105 of the heating device with four groups of initiation heaters and four groups of emission heaters and with a common conductor, with external thermal initiation of the heating process by means of electric current, structured as a flow-through system for liquid heating (constructed pursuant to claim 29).

The determined temperature of liquid heating is 75° C. and it can be displayed on the display unit of the electronic temperature regulator 70. The flow-through system of liquid heating comprises a heating device 80 connected according to the connection scheme 105 of the heating device with four groups of initiation heaters and four groups of emission heaters and a common conductor to the control system 85 through the communication interface 106 of the connection of the heating device to the input of the control system. The socket 81 for the heated liquid supply and the socket 84 for liquid removal are connected to the screw threads on the inner surface 27 of the composed heating device. The thermal insulation 92 is located on the case 10 of the heating device. The heating device 80 is being heated upon supply of electric energy to the initiation heater 41 and to the emission heater 42 from the PWM modulator 110 up to the level of the start of the LENR reaction in the initiation heater 41 and in the emission heater 42. The software of the control system 85 ensures its functioning in the mode of a thermostatic regulator (controller) and provides precise measurements of the resistance values of the heaters during cyclical step-by-step connecting of individual sections of the heater by means of the voltage supply as well as measurements of the resistance value of the heaters within the zone where the LENR reaction takes place by means of measuring the values of the flowing current. During this process, the control and maintenance of the parameters of the heating device operation is ensured based on the main characteristic, i.e. the electric resistance of individual sections of the heaters measured during the operation process—measuring and calculation of the speed or acceleration (the first derivation d′i/dt, or acceleration, the second derivation d″i/dt²) based on the value of the electric current passing through the sections of the heaters, which is the function of the inside temperature of the ceramic heater at which the LENR reaction occurs. And because the initiation thermal energy is supplied in a cyclical manner, the control function is ensured through the cyclical passage of current through the heater in the mode of the output (power) supply and measuring of the resistance of the heaters within the zone where the LENR reaction takes place, for the purpose of analysing the resistance change in cyclical modes with the measuring repetition frequency of 100 times per second.

The control system 85 comprises hardware and software adapted to multi-channel measuring of resistance of four composed sections of initiation heaters 41 and emission heaters 42 and the control of temperature modes of the LENR reaction process in such composed devices, ensuring cyclical mode of the output (power) supply and measuring of the resistance of the heaters within the zone where the LENR reaction takes place, for the purpose of analysing the resistance change in cyclical modes with the measuring repetition frequency of 100 times per second in the resistors of the measuring unit 104 with eight resistors for measuring the voltage of the heater or a section of the heater. In such composed four-sectional heating device, the control of eight heaters is performed and the control system 85 controls the sections of the heating device with coupled initiation heaters and emission heaters—voltage measuring at the resistors (R₁-R₅); (R₂-R₆); (R₃-R₇); (R₄-R₈) in cycles of step-by-step supply of output (power) and control of the resistance level within the zone where the LENR reaction takes place. This is performed by means of structuring the synchronised cycles of the output supply of the initiation heating or measuring at the determined channel from 1 to 8, with the output (power) supply from the PWM modulator 110, supplying current in steps from its output to the resistor couples R₁-R₅; R₂-R₆; R₃-R7; R₄-R₈ of the measuring unit 104 with eight resistors, based on the software adapted for the given type of the heating device.

In the course of this process, the specific current impulses from the PWM modulator 110 continue to flow to the heater with a reduced output at the level of 10% of the nominal value of the output for the purpose of controlling the resistance within the zone where the LENR reaction takes place. When the measured value of resistance is lower by 10% compared to the value measured in the preceding measuring, the thermal impact is disconnected by means of switching off the output (power) supply from the PWM modulator 110 to the heating device. Furthermore, in the course of the electric current passing from the PWM modulator 110 to the heater with a reduced output at the level of 10% of the nominal value at the relevant section of the initiation heater 41, the control of resistance increase at the heater is ensured and if the measured value of resistance increases by 10% of its value measured at the moment of the thermal impact disconnection (switch-off), the process of the output supply to the section of the initiation heater 41 is repeated as described above.

Upon starting the LENR reaction maintenance mode, the electric power supply of the emission heater 42 from the PWM modulator 110 is interrupted and the control system 85 continues to operate in the thermo-stabilisation mode of the initial heater 41 within the temperature range ensuring the thermal output required for the operation of the emission heater 42 and for maintaining the LENR reaction therein.

Such cycles of controlling the heating device are ensured by the software and can be adapted to various construction alternatives of the heating devices in line with the principles described above.

The system also analyses the temperature values coming from the temperature sensor 23 at the heat exchanger (t₂° C.), recording the temperature on the coat of the heat exchanger, from the temperature sensor 22 of the temperature at the input (t₁° C.), placed at the liquid supply socket, and from the temperature sensor 24 of the liquid at the outlet (t₃° C.), placed at the liquid removal socket 84, based on which signals the electric energy supply to the section of the heaters of the heating device can be disconnected when the temperatures increase above the level of common operation or if the liquid temperature exceeds 95° C. The control system 85 also controls the liquid supply pump 82 that regulates the speed of the liquid supply and receives signals at the input originating from the liquid flow meter 83. Any changes of the parameters of the control system 85 operation and its programming are performed from external devices through the communication computer interfaces 126 for the connection of external devices.

An example of industrial use of the invention, various alternatives of the device using the heating devices in the structure of flow-through and accumulation systems for liquid heating, convector heaters and heating radiators. The liquid heating systems of different construction alternatives function in the following manner:
Examples of the construction of liquid heating systems utilising the thermal energy from the combustion of hydrocarbon fuel. Example of implementation of a liquid heating system of accumulation type pursuant to claim 26, as illustrated in FIG. 18.

The construction of the system meets the requirements pertaining to the given type of devices of heating liquids and contains standard and known elements and devices used in this type of appliances. The main difference is the existence of a composed heating device, constructed for example pursuant to claim 18, with the initiation of the external heat impact by means of the hydrocarbon fuel burner 21, the scheme of which is illustrated in FIG. 10a.

The liquid heating system of accumulation type and the heating device function in the following manner:

Upon setting the temperature of the liquid heating by the electronic temperature regulator 70 that constitutes a part of the control system 85 for example to the value of 75° C., the thermal energy is being supplied to the inner surface 27 of the composed heating device 80 installed on the flange 11 of the heating device base equipped with openings 12 in the flange used for the fixation of the heating device from the burner 21 for hydrocarbon fuel to which the fuel is being supplied through the closure valve 86. Upon launching the operation, the control system 85 initiates thermal heating of the initiation heater 41 and of the emission heater 42 by means of supplying electric energy, as described above, and controls the heating of the initiation heater 41 and of the emission heater 42 of the heating device 80 in individual sections and when the initialisation temperature of the LENR reaction in the heaters is reached, the control system switches off the electric energy supply and subsequently regulates the supply of the external thermal impact on the inner surface 27 of the composed heating device only from the burner 21 for hydrocarbon fuel. The activity of the burner 21 for hydrocarbon fuel is controlled by the control system 85 by means of switching on or off the closure valve 86 in the start/stop mode, during the operation in the thermostabilisation mode of the heated liquid inside the thermally insulated accumulation tank 87. Determination of the current temperatures transmitted to the control system input 85 originates from the liquid temperature sensor 22 at the input t₁° C., liquid temperature sensor 23 at the heat exchanger t₂° C. and liquid temperature sensor 24 at the output t₃° C. The data from the liquid flow meter 83 are also transmitted to the input of the control system 85 and the liquid supply pump 82 is connected to the input of the control system as well. In order to improve the heat sharing with the liquid volume inside the thermally insulated accumulation tank 87, a heat exchanger 88 is installed on the surface of the outer case 10 of the heating device. All the devices forming a part of the liquid heating system ensure the temperature thermostabilisation mode inside the thermally insulated accumulation tank 87 by means of connection or disconnecting the thermal energy supply to the heating device 80 and by means of maintaining its operation within the pre-determined temperature range within the zone of LENR reaction in the heaters. The existence of four sections of the initiation heater 41 and of the emission heater 42 of the heating device 80 enables the use of its separate sections in the temperature maintenance mode in the liquid volume. In the course of heating the inner surface 27 with the burner 21 for hydrocarbon fuel, combustion products are generated that are subsequently released to the atmosphere.
Another example of the liquid heating system is the flow-through system of heating liquids with the use of gas heating, implemented pursuant to claim 27, as illustrated in FIG. 19.

The construction of the system meets the requirements pertaining to the given type of devices of heating liquids and contains standard and known elements and devices used in this type of appliances. This type also uses the form of a composed heating device, constructed for example pursuant to claim 21, with the initiation of the external heat impact, the scheme of which is illustrated in FIG. 12.

In this type of construction, the liquid heating system of flow-through type and the heating device function in the following manner:

Upon setting the temperature of the liquid heating by the electronic temperature regulator 70 that constitutes a part of the control system 85 for example to the value of 75° C., the initiation thermal energy is being supplied to the case 10 of the heating device installed on the flange 11 of the heating device base equipped with openings 12 in the flange used for the fixation of the heating device from a series of the connected burners burner 21 for hydrocarbon fuel to which the fuel is being supplied through the closure valve 86. This system counts on the burners being controlled by means of an adaptive mode of control, where the control unit 90 of the fuel supply to the burners can regulate the output of the thermal energy supply to the case 10 of the heating device by means of controlling the burners 21 for hydrocarbon fuel through the control system 85, which is ensured by the appropriate hardware and software tools. In line with the standard procedures, the control system 85 upon launching the operation initiates thermal heating of the initiation heater 41 and of the emission heater 42 by means of supplying electric energy, as described above, and controls the heating of the initiation heater 41 and of the emission heater 42 of the heating device 80 in individual sections and when the initialisation temperature of the LENR reaction in the heaters is reached, the control system switches off the electric energy supply and subsequently regulates the supply of the external thermal impact on the inner surface 27 of the composed heating device only from the burner 21 for hydrocarbon fuel. This construction alternative of the system primarily uses burners for the liquid heating structured in the form of a series of burners 21 for hydrocarbon fuel heating the case 10 of the heating device from four sides at different heights, thus ensuring spatial heating in individual sections of the heaters.

The activity of the burner 21 for hydrocarbon fuel by means of switching on or off the closure valve 86 in the start/stop mode, as well as the analog control of its output, is performed by the control system 85 during the operation in the thermo stabilisation mode of the heated liquid inside the thermally insulated accumulation tank 87, controlled by the regulation unit 90 controlling the output of the burners 21 for hydrocarbon fuel and the heat impact on the heating device. Determination of the current temperatures transmitted to the control system input 85 originates from the liquid temperature sensor 22 at the input t₁° C., liquid temperature sensor 23 at the coat of the heating device t₂° C. and liquid temperature sensor 24 at the heat output t₃° C. The data from the liquid flow meter 83 are also transmitted to the input of the control system 85 and the liquid supply pump 82 is connected to the input of the control system 85 as well. All the devices forming a part of the liquid heating system ensure the temperature thermo stabilisation mode inside the thermally insulated accumulation tank inner surface 27 of the composed heating device by means of connecting or disconnecting the thermal energy supply to the heating device 80 and by means of maintaining its operation within the pre-determined temperature range within the zone of LENR reaction in the heaters. The existence of four sections of the initiation heater 41 and of the emission heater 42 of the heating device enables the use of its separate sections in the temperature maintenance mode in the flowing liquid volume. In the course of heating the case 10 of the heating device with the burner 21 for hydrocarbon fuel, for example combustion gas, combustion products are generated that are subsequently released to the atmosphere.

### Example of the Construction of lLquid Heating Systems Utilising the Electric Energy

Example of implementation of a liquid heating system of accumulation type pursuant to claim 28, as illustrated in FIG. 20.

The construction of the system meets the requirements pertaining to the given type of devices of heating liquids and contains standard and known elements and devices used in this type of appliances. The main difference of the system is the existence of a composed heating device, constructed for example pursuant to claim 20, with the initiation of the external heat impact with the use of electric energy, the scheme of which is illustrated in FIG. 11d. The liquid heating system of accumulation type and the heating device function in the following manner:

Upon setting the temperature of the liquid heating by the electronic temperature regulator 70 that constitutes a part of the control system 85 for example to the value of 75° C., the initiation thermal energy is being supplied to the heating device 80 installed on the flange 11 of the heating device base, equipped with openings 12 for the fixation of the heating device, from the control system 85 which is ensured by the relevant hardware and software tools. Upon launching the operation, the control system 85 initiates thermal heating of the initiation heater 41 and of the emission heater 42 by means of supplying electric energy, as described above, and controls the heating of the initiation heater 41 and of the emission heater 42 of the heating device in individual sections and when the initialisation temperature of the LENR reaction in the heaters is reached, the control system 85 switches off the electric energy supply and subsequently regulates the supply of the external thermal impact on the initiation heater 41 or its sections only from the electric energy supply unit. All the elements constituting the heating system are controlled by the control system 85 in the thermo stabilisation mode of the heated liquid temperature inside the thermally insulated accumulation tank 87. Determination of the current temperatures transmitted to the control system input 85 originates from the liquid temperature sensor 22 at the input t₁° C., liquid temperature sensor 23 at the heat exchanger t₂° C. and liquid temperature sensor 24 at the output t₃° C. The data from the liquid flow meter 83 are also transmitted to the input of the control system 85 and the liquid supply pump 82 is connected to the input of the control system 85 as well. In order to improve the heat sharing with the liquid volume inside the thermally insulated accumulation tank 87, a heat exchanger 88 is installed on the surface of the outer case 10.

All the devices forming a part of the liquid heating system ensure the temperature thermo stabilisation mode inside the thermally insulated accumulation tank 87 by means of connecting or disconnecting the thermal energy supply to the heating device and by means of maintaining its operation within the pre-determined temperature range within the zone of LENR reaction in the heaters. The existence of four sections of the initiation heater 41 and of the emission heater 42 of the heating device enables the use of its separate sections in the temperature maintenance mode in the flowing liquid volume.
Another example of the liquid heating system is the flow-through system of heating liquids with the use of electric heating, implemented pursuant to claim 29, as illustrated in FIG. 21.

This type also uses the form of a composed heating device, constructed for example pursuant to claim 22, with the initiation of the external heat impact, the scheme of which is illustrated in FIG. 13d.

In this type of construction, the liquid heating system of flow-through type and the heating device function in the following manner:

Upon setting the temperature of the liquid heating by the electronic temperature regulator 70 that constitutes a part of the control system 85 for example to the value of 75° C., the initiation thermal energy is being supplied to the heating device 80 installed on the flange 11 of the heating device base, equipped with openings 12 for the fixation of the heating device, from the control system 85 which is ensured by the relevant hardware and software tools.

In line with the standard procedures, the control system 85 upon launching the operation initiates thermal heating of the initiation heater 41 and of the emission heater 42 by means of supplying electric energy, as described above, and controls the heating of the initiation heater 41 and of the emission heater 42 of the heating device in individual sections and when the initialisation temperature of the LENR reaction in the heaters is reached, the control system 85 switches off the electric energy supply and subsequently regulates the supply of the external thermal impact on the inner surface 27 of the composed heating device only by means of the electric energy supply to the initiation heater 41 or its sections. For this construction alternative of the liquid heating system, heating devices with thermal insulation 92 of the outer surface are preferentially used.

The operation of the heating device with the switching off or switching on the electric energy supply is controlled by the control system 85 during the operation in the mode of thermo stabilisation of the temperature of the liquid flowing through the inner surface 27 of the composed heating device at the level of the thermal impact on the heating device. Determination of the current temperatures transmitted to the control system input 85 originates from the liquid temperature sensor 22 at the input t₁° C., liquid temperature sensor 23 at the heat exchanger t₂° C. and liquid temperature sensor 24 at the output t₃° C. The data from the liquid flow meter 83 are also transmitted to the input of the control system 85 and the liquid supply pump 82 is connected to the input of the control system 85 as well.

All the devices forming a part of the liquid heating system ensure the temperature thermo stabilisation mode inside the thermally insulated accumulation tank inner surface 27 of the composed heating device by means of connecting or disconnecting the thermal energy supply to the heating device 80 and by means of maintaining its operation within the pre-determined temperature range within the zone of LENR reaction in the heaters. The existence of four sections of the initiation heater 41 and of the emission heater 42 of the heating device enables the use of its separate sections in the temperature maintenance mode in the flowing liquid volume.

As indicated by the example, the heating device 80 used in various construction alternatives of liquid heating systems is hermetically fixed to the attachment flange 11 of the heating device base equipped with openings 12 in the flange used for the fixation of the heating device and its operation can be changed alternatively in the required intervals.

### Example of Convection Systems of Air Heating

Example of the construction of a convection heater pursuant to claim 30 with the alternative of a convection tubular electric heater pursuant to claim 24, as illustrated in FIG. 22.

The main difference of the system is the existence of a composed heating device, constructed for example pursuant to claim 23, with the initiation of the external heat impact with the use of electric energy, the scheme of which is illustrated in FIG. 14d.

The convection heater with a tubular electric heater functions as follows:

Upon setting the temperature of the air heating by the electronic temperature regulator 70 that constitutes a part of the control system 85 in the room where the heater is located, for example to the value of 25° C., the thermal energy is being supplied to the heating device 80 installed on the flange 13 of the heating device base, equipped with an external screw thread on the tubular electric heater. Upon launching the operation, the control system 85 initiates thermal heating of the initiation heater 41 and of the emission heater 42 by means of supplying electric energy, as described above, and controls the heating of the initiation heater 41 and of the emission heater 42 of the heating device in individual sections and when the initialisation temperature of the LENR reaction in the heaters is reached, the control system 85 switches off the electric energy supply and subsequently regulates the electric energy supply to the initiation heater 41 or its sections only by means of supplying electric energy. All the elements constituting the heating system are controlled by the control system 85 in the thermo stabilisation mode of the heated liquid temperature inside the convection tubular electric heater 50 up to 110° C. Determination of the current temperatures transmitted to the control system input 85 originates from the sensor 72 of the temperature on the radiator board place t₁° C., from the sensor 73 of the temperature on the outside surface of the radiator t₂° C. and from the sensor 74 of the temperature within the zone of installation of the heating device mounting t₃° C. An electric fan 67 is connected to the output of the control system 85.

All the devices forming a part of the convection tubular electric heater ensure the thermo stabilisation mode of the pre-determined temperature inside the heating unit 50 by means of connecting or disconnecting the thermal energy supply to the heating device 80 and by means of maintaining its operation within the pre-determined temperature range within the zone of LENR reaction in the heaters of the heating device 80. The existence of four sections of the initiation heater 41 and of the emission heater 42 of the heating device enables the use of its separate sections in the mode of maintaining the required temperature in the heating unit convection tubular electric heater 50.
Example of an alternative of the convection radiator with electric heating of tubular heating unit—implemented pursuant to claim 30, as illustrated in FIG. 22a.

Upon launching the operation, the control system 85 initiates thermal heating of the initiation heater 41 and of the emission heater 42 by means of supplying electric energy, as described above, and controls the heating of the initiation heater 41 and of the emission heater 42 of the heating device in individual sections and when the initialisation temperature of the LENR reaction in the heaters is reached, the control system 85 switches off the electric energy supply and subsequently regulates the supply of the external electric energy to the initiation heater 41 or its sections only by means of supplying electric energy. All the elements constituting the heating system are controlled by the control system 85 in the thermo stabilisation mode of the heated liquid temperature inside the convection tubular electric heater 50 up to 110° C. Determination of the current temperatures transmitted to the control system input 85 originates from the sensor 72 of the temperature on the radiator board place t₁° C., from the sensor 73 of the temperature on the outside surface of the radiator t₂° C. and from the sensor 74 of the temperature within the zone of installation of the heating device mounting t₃° C. All the devices forming a part of the convection heater ensure the thermo stabilisation mode of the pre-determined temperature inside the heating unit convection tubular electric heater 50 by means of connecting or disconnecting the thermal energy supply to the heating device 80 and by means of maintaining its operation within the pre-determined temperature range within the zone of LENR reaction in the heaters of the heating device 80. The existence of four sections of the initiation heater 41 and of the emission heater 42 of the heating device enables the use of its separate sections in the mode of maintaining the required temperature in the heating unit convection tubular electric heater 50.

As indicated by the example, the heating device 80 used in various construction alternatives of convection heaters is hermetically by means of the screw thread connection 15 to the attachment flange at the lower part 13 of the heating device with external screw thread base and its operation can be changed alternatively in the required intervals.

The priorities of this invention and its advantages in the described examples lie in the possible modifications and alternatives necessary to be included within the scope of the protection claims attached hereto.

The above description may be interpreted as the publishing of this invention that should not be understood as limiting its priorities. The presented methods and construction alternatives of the submitted invention have been described in sufficient detail and the experts in the given field will understand that there are other possible modifications of the construction alternatives hereof, without any significant deviations from the substance of the methods described in the application.

In view of the above, all such modifications can be included within the scope of this invention, provided that they comply with the definitions described in the protection claims and in the construction alternatives described above.

For this reason, it is necessary to understand that descriptions provided above are intended to illustrate this invention for information purposes only and should not be interpreted as any limitations in the form of the specific construction alternatives described herein and that any modifications of the construction alternatives described herein, as well as any other alternatives, are also intended to be covered within the scope of the presented protection claims.

This invention is defined by the protection claims attached hereto and any equivalent claims describing additional possible modifications of its methods and devices should further increase its priority.

1. A method of producing thermal energy, comprising the use of chemical elements involved in the exothermic reaction of the Low Energy Nuclear Reaction (LENR) during the interaction of a reactive material consisting of a catalyst in the form of metal powder of the elements of the 10th group of the Periodic Table, in particular nickel (Ni), and a fuel mixture of hydrogen-containing chemical compounds of aluminium (al) and lithium (Li), such as lithium aluminium hydride (LiAlH₄), under conditions initializing external thermal effect, where the controlled LENR reaction is obtained through the use of a heater (1) produced as a porous ceramic electrically conductive tubular element with a reaction material being placed in its pores, the inner surface of which is being heated and the thermal energy is being removed from the outer surface, with metal contacts (2) of the upper part of the heater and metal contacts (3) of the lower part of the heater being placed on the opposite ends of the heater, connected to the input of the control system (85) for controlling the electric resistance in the heater, for which purpose they are subjected to voltage and the current value is being measured, and the first and/or second derivative of the current is being calculated, based on which the temperature is being maintained at which the LENR process occurs, by means of disconnecting or connecting the thermal energy supply to the heater (1) and the reaction material within the range minus (5-10%) of the initial melting temperature of the catalyst, for which purpose the thermal energy connection/disconnection control devices are connected to the control system (85) output.

2. The method pursuant to claim 1, wherein the heater (1) is receiving thermal energy by burning hydrocarbon fuels, primarily fuel gas.

3. The method pursuant to claim 2, wherein the heater (1) is receiving thermal energy to the outer surface and the thermal energy is being removed from its inner surface.

4. The method pursuant to claim 1, wherein the heater (1) is receiving thermal energy by means of electric current passing through it, conducted via metal contacts.

5. A method of obtaining additional thermal energy and increasing the efficiency through the use of a ceramic electrically conductive element with a reaction material placed in its pores, produced as two electrically insulated coaxial cylindrical bodies components constituting the initiation heater (41) and the emission heater (42); the initiation heater (41) receives external heating energy and heats the emission heater (42), with the produced thermal energy being removed from the outer surface of the emission heater (42), metal contact outputs are placed on the opposite ends of the heater, connected to the input of the control system (85) for controlling the electric resistance in the heaters, for which purpose they are subjected to voltage and the current value is being measured, and the first and/or second derivative of the current is being calculated, based on which the temperature is determined at which the LENR process occurs and this temperature is being maintained by means of disconnecting or connecting the thermal energy supply to the heaters and the reaction material within the range minus (5-10%) of the initial melting temperature of the catalyst, for which purpose the thermal energy connection/disconnection control devices are connected to the control system (85) output.

6. The method pursuant to claim 5, wherein the initiation heater (41) is receiving thermal energy by combusting hydrocarbon fuels, primarily fuel gas.

7. The method pursuant to claim 5, wherein the initiation heater (41) is receiving thermal energy by passing electric current guided through the terminal (44) of the common contact, through the terminal (45) of the initiation heater and through the terminal (46) of the emission heater.

8. The method pursuant to claim 7, wherein the initiation heater (41) is placed outside and the emission heater (42) is placed inside, and the thermal energy is being removed from the inner surface of the emission heater (42).

9. The method pursuant to claim 5, wherein the volume ratio of the cylindrical coaxial bodies comprising the initiation heater (41) and the emission heater (42) is 1:3, and subject to the condition of equal height ratio, the ratio of the wall thickness of the initiation heater (41) and the emission heater (42) is ≤3 with the internal supply of thermal energy and ≤1/3 with the external supply of thermal energy.

10. The method pursuant to claim 5, wherein the initiation heater (41) and the emission heater (42) are divided into two or more sections with the aim of achieving smooth control of the output power, whereby each section contains a terminal (44) of the common contact, a terminal (45) of the initiation heater and a terminal (46) of the emission heater.

11. The method wherein the heater (1) structured as a porous ceramic electrically conductive tubular element made of a high-temperature ceramic containing a mixture of powders SiC, ZrO₂, Al₂O₃ and carbon (C) powder, and a reaction material, containing a metallic catalyst powder in the form of metal powder of the elements of the 10th group of the Periodic Table, in particular nickel (Ni), and a fuel mixture, is proportionally distributed inside the pores in a ratio ranging between 10 and 80% of the surface of the ceramic pores.

12. The method wherein the heater (1) structured as a porous ceramic electrically conductive tubular element made of a high-temperature ceramic according to claim 11 above is characterised by the high-temperature ceramic already containing in its composition a metallic catalyst powder in the form of metal powder of the elements of the 10th group of the Periodic Table, in particular nickel (Ni).

13. The method pursuant to claims 5 and 10, characterised by the fact, that in order to accelerate the initiation of the LENR reaction, the initiation heater (41) and the emission heater (42), or the respective sections thereof, in the initial stage receive thermal energy by means of passing electric current guided through metal contacts.

14. The heating device, comprising a heater (1) pursuant to claim 2, receiving external thermal energy of the heating during the combustion of a hydrocarbon fuel, preferentially combustion gas, on the inner surface (7) of the heating device, placed in a hermetically sealed cylindrical case (10) of the heating device, made of high-temperature withstanding metal, preferably nickel (Ni), with a ceramic insulation insert (6) for the sealing and insulation of the contact terminals in the area of the fixing flange (11) of the heating device base, and containing thermally insulated surfaces for heating and removal of thermal energy.

15. The heating device of flow-through type, pursuant to claim 14, characterised by the fact, that the inner surface (7) of the heating device forms a flow chamber and its end exit sleeves are equipped with screw threads for the connection of the socket (81) for the liquid supply and the socket (84) for the liquid removal, where the outer surface of the heating device receives the heating energy during the combustion of hydrocarbon fuel, preferentially combustion gas.

16. The heating device, implemented pursuant to claim 4, wherein a heater (1) receiving external thermal energy of the heating by means of the supply of electric voltage, with metal contacts (2) of the upper part of the heater and metal contacts (3) of the lower part of the heater being placed on the opposite ends, connected to the electric conductors made of high-temperature withstanding metal, is placed in a hermetically sealed cylindrical case (10) of the heating device, made of high-temperature withstanding metal, preferably nickel (Ni) alloy, with a ceramic insulation insert (6) for the sealing and insulation of the contact terminals in the area of the fixing flange (11) of the heating device base, and containing a surface for removal of thermal energy.

17. The heating device of flow-through type, pursuant to claim 16, characterised by the fact, that the inner surface of the heating device forms a flow chamber and its end exit sleeves are equipped with screw threads for the connection of the socket (81) for the liquid supply and the socket (84) for the liquid removal.

18. The heating device, implemented pursuant to claim 5, wherein an initiation heater (41) receiving external thermal energy of the heating by means of the supply of electric voltage or by means of combustion of hydrocarbon fuel, preferentially combustion gas, and an emission heater (42), are constructed as two electrically insulated coaxial cylindrical bodies with metal contacts placed on the opposite ends, connected to the electric conductors made of high-temperature withstanding metal, preferentially nickel (Ni) or nickel alloys, with the ends of the initiation heater (41) and the emission heater (42) being connected at one side and having one terminal (44) of the common contact guided through the middle of the initiation heater (41), placed in a hermetically sealed cylindrical case (10) of the heating device, made of high-temperature withstanding metal, preferably nickel (Ni) alloy, with a ceramic insulation insert (6) for the sealing and insulation of the contact terminals in the area of the fixing flange (11) of the heating device base, and containing surfaces for the heating and removal of thermal energy, specifically the inner surface (27) of the composed heating device or the case (10) of the heating device, depending on the particular alternative of the heating device.

19. The heating device, implemented pursuant to claim 8, wherein an initiation heater (41) receiving external thermal energy of the heating and an emission heater (42), are constructed as two electrically insulated coaxial cylindrical bodies with metal contacts placed on the opposite ends, connected to the electric conductors made of high-temperature withstanding metal, preferentially nickel (Ni) or alloys of nickel (Ni) and chrome (Cr), with the ends of the initiation heater (41) and the emission heater (42) being connected at one side and having one terminal (44) of the common contact, placed in a hermetically sealed cylindrical case (10) of the heating device, made of high-temperature withstanding metal, preferably nickel (Ni) alloy, for the removal of thermal energy, with a ceramic insulation insert (6) for the sealing and insulation of the contact terminals in the area of the fixing flange (11) of the heating device base.

20. The heating device, implemented pursuant to claim 19, wherein an initiation heater (41) divided into two, three or four sections, each of which has metal contacts connected to the control system (85), receiving external thermal energy of the heating and an emission heater (42) divided into two, three or four sections, each of which has metal contacts connected to the control system (85), are constructed as two electrically insulated coaxial cylindrical bodies with metal contacts placed on the opposite ends, connected to the electric conductors made of high-temperature withstanding metal, preferentially alloys of nickel (Ni) and chrome (Cr), with the ends of the initiation heater (41) and the emission heater (42) being connected at one side and having one terminal (44) of the common contact, placed in a hermetically sealed cylindrical case (10) of the heating device, made of high-temperature withstanding metal, preferably nickel (Ni) alloy, for the removal of thermal energy, with a ceramic insulation insert (6) for the sealing and insulation of the contact terminals in the area of the fixing flange (11) of the heating device base.

21. The heating device pursuant to claim 20, characterised by the fact, that the initiation heater (41) receives the external thermal energy of the heating during combustion of hydrocarbon fuel, preferentially combustion gas, by means of four burners and the inner surface of the emission heater (42) forms a flow chamber and its end exit sleeves are equipped with screw threads for the connection of the socket (81) for the liquid supply and the socket (84) for the liquid removal.

22. The heating device pursuant to claim 20, characterised by the fact, that the initiation heater (41) sections receive the external thermal energy of the heating by means of electricity supply and the inner surface of the emission heater (42) forms a flow chamber.

23. The heating device pursuant to claims 16, 19, 20, characterised by the fact, that it contains a metal case (14) covered with porous ceramic material and that it is equipped with a screw thread (15) for mounting.

24. The convection tubular electric heater, configured as a two-lamella convection tubular electric eater (50) with a vertical heat-conductive panel (64), on which a two-lamella radiator is fixed, with the developed surface and an angle of 95°-110° between the lamellae, characterised by the fact, that the tubular element (55) is placed on the vertical heat-conductive panel (64) at an angle of 15°-25° and that the heating device implemented pursuant to claim 23, with a metal case (14) covered with porous ceramic material, is hermetically fixed to the screw thread (15) at the lower part of the tubular element (55), with the other end being hermetically sealed, and with the inside of the tubular element (55) being filled with a liquid with the boiling point between 95° C. and 115° C. up to the level covering the surface of the heating device.

25. The convection tubular heater pursuant to claim 24, configured as a tubular four-lamella heater (53), characterised by the fact, that the lamellae (56) of the radiator with the developed surface are fixed on the tubular element (55) at an angle of 95°-110° between the lamellae.

26. The liquid heating system of accumulation type, comprising a thermally insulated accumulation tank (87) filled with liquid, a socket (81) for the liquid supply and a socket (84) for the liquid removal, burner (21) of the hydrocarbon fuel with a closure valve (86) connected to the source of hydrocarbon fuel, heating device (80) constructed pursuant to claim 18, fixed on the flange (11) of the heating device base and placed inside the cylindrical heat exchanger (88) equipped with a radiator in the form of radial plates, combustion products trap (91) and an outlet channel of the combustion products, control system (85), to which the heating device (80) is connected, temperature sensor (23) of the heat exchanger coat (t₂° C.), liquid temperature sensor (22) at the input (t₁° C.) and liquid temperature sensor (24) at the output (t₃° C.), control unit (90) of the fuel supply to the burners, closure valve (86) for closing the supply of hydrocarbon fuel when the temperatures exceed the level of the usual operation or when the liquid temperature exceeds 95° C., and an electronic temperature regulator (70) used for determination of the required temperature values of the liquid heating.

27. The liquid heating system of flow-through type, comprising a heating device (80), constructed pursuant to claim 21, fixed on the flange (11) of the heating device base, with the socket for the liquid supply (81) and the socket for the liquid removal (84) being mounted to the screw threads of the inner surface (27) of the composed heating device, equipped with four combined three-jet burners (21) of hydrocarbon fuel placed at the outside of the heating device (80), combustion chamber and a combustion products trap (91), control system (85) to which four control units (90) are connected for the supply of hydrocarbon fuel to the burners on four channels of hydrocarbon fuel supply, to control burners (21) of hydrocarbon fuel, liquid temperature sensor (22) at the input (t₁° C.), placed on the socket (81) for the liquid supply, liquid temperature sensor (24) at the output (t₃° C.), placed on the socket (83) for the liquid removal, temperature sensor (23) of the heat exchanger coat (t₂° C.), closure valve (86) for closing the supply of hydrocarbon fuel when the temperatures exceed the level of the usual operation or when the liquid temperature exceeds 95° C., liquid supply pump (82) regulating the speed of the heated liquid supply, flow meter (83) of the liquid and an electronic temperature regulator (70) used for determination of the required temperature values of the liquid heating.

28. The liquid heating system of accumulation type, with a possibility of continuous regulation of the heating output, comprising a thermally insulated accumulation tank (87) filled with liquid, a socket (81) for the liquid supply and a socket (84) for the liquid removal, a heating device (80) constructed pursuant to claims 16, 19, 20, fixed on the flange (11) of the heating device base and placed inside the cylindrical heat exchanger (88) equipped with radial plates, control system (85), to which the heating device (80) is connected, as well as the liquid temperature sensor (22) at the input (t₁° C.), placed on the socket (81) for the liquid supply, liquid temperature sensor (24) at the output (t₃° C.) placed on the socket (84) for the liquid removal, temperature sensor (23) of the heat exchanger coat (t₂° C.), the signals of which are used for the disconnection of the heating device (80) from the electric energy supply when the temperatures exceed the level of the usual operation or when the liquid temperature exceeds 95° C., and an electronic temperature regulator (70) used for determination of the required temperature values of the liquid heating.

29. The liquid heating system of flow-through type, wherein a heating device (80), constructed pursuant to claims 17, 21, 22, is fixed on the flange (11) of the heating device base on the screw threads of the inner surface (27) of the composed heating device, connected to the socket (81) for the liquid supply and the socket (84) for the liquid removal, thermal insulation (92) of the outer surface of the heating device (80) and the control system (85), to which the heating device (80) is connected, as well as the temperature sensor (23) of the heat exchanger coat (t₂° C.), liquid temperature sensor (22) at the input (t₁° C.) placed on the socket (81) for the liquid supply, liquid temperature sensor (24) at the output (t₃° C.) placed on the socket (84) for the liquid removal, temperature sensor (23) of the heat exchanger coat (t₂° C.), the signals of which are used for the disconnection of the heating device (80) from the electric energy supply when the temperatures exceed the level of the usual operation or when the liquid temperature exceeds 95° C., liquid supply pump (82) regulating the speed of the heated liquid supply, liquid flow meter (83) and an electronic temperature regulator (70) used for determination of the required temperature values of the liquid heating.

30. The convection heater wherein is a frame formed by the front panel (61) of the radiator, back panel (69) of the radiator, inside which a two-lamella convection tubular electric heater (50) is fastened on the mounting brackets (66), constructed pursuant to claim 24, an output upper deflector (65), an inlet lower deflector (68) and the control system (85), to which the heating device constructed pursuant to claim 23 is attached, as well as the temperature sensor (72) on the radiator board, used for disconnecting the electric energy supply when the temperature on the surface exceeds 75° C.-95° C., a temperature sensor (73) on the outer surface of the radiator, used for measuring the outside temperature, and a temperature sensor (74) within the zone where the heating device is mounted, an electronic temperature regulator (70) used for determination of the required temperature values and an electric fan (67) used for regulation of the air flow speed on the surface of the convection radiator.

31. The convection heater constructed pursuant to claim 25, characterised by the fact, that a tubular four-lamella heater (53) pursuant to claim 25 is installed inside, and further containing the control system (85), to which the heating device constructed pursuant to claim 23 is attached, as well as the temperature sensor (72) on the radiator board, used for disconnecting the electric energy supply when the temperature on the surface exceeds 75° C.-95° C., a temperature sensor (73) on the outer surface of the radiator, used for measuring the outside temperature, a temperature sensor (74) within the zone where the heating device is mounted, and an electronic temperature regulator (70) used for determination of the required temperature values.

32. The control system (85) based on a microcomputer (101), as the main control device and with specialised software, implemented for functioning in accordance with the methods and devices pursuant to claims 1 through 31, in combination with the liquid heating systems of accumulation or flow-through type or convection heaters with various alternatives of heating devices utilising energy from the hydrocarbon fuel sources or from electric sources, having terminal groups of contacts for the connection of one up to eight contacts of the heater (1) or of the sections of the initiation heater (41) and the emission heater (42) and the common contact, led to the measuring unit (104) with eight resistors connected to the 8-channel PWM (Pulse Width Modulator) (110) of the electric output, connected to the supply source (125) and to a microcomputer (101); the electric voltage measured at the resistors is led to the input of the 8-channel analogue multiplexer (108) connected to a microcomputer (101); the voltage values measured at the output of the analogue multiplexer (108) are led to the input of the ADC converter (109), the output of which is also connected to the input of the microcomputer (101); in addition, the system contains the end group (115) of contacts for the connection of temperature sensors determining the temperature of the heating device, the liquid and air; the temperature sensors (114) are connected to the 4-channel ADC converter (116), from which the data is transmitted to the input of the microcomputer (101); the liquid flow sensor (111) is connected to the input of the signal digitisation block (113) from the liquid flow meter sensor and then to the input of the microcomputer (101), the end group (119) of contacts for the connection of the hydrocarbon fuel burners, connected with the 4-channel DAC converter (118) to the control unit (117) of the hydrocarbon fuel burners and the end group (120) of contacts for the connection of the closure valves of hydrocarbon fuel burners connected to the control unit (117) of the hydrocarbon fuel burners, connected to the output of the microcomputer (101); in addition, the system contains the end group (123) of contacts for the connection of external devices with relay contacts for controlling the pumps, fans and/or other analogue devices needed for the operation of the heating system; other devices connected to the microcomputer (101) include electronic regulator (70) of the heating temperature that determines the required temperature values of the heating of the controlled devices, heating of the liquid, volume of the ambient air, supply source (125) and other devices of the control system (85), which also has a standard computer communication interfaces (126) for the connection of external devices used for programming, monitoring and recording information.
